(19) United States
(12) Patent Application Publication
(10) Pub. No.: US 2015/0242579 A1
(43) Pub. Date: Aug. 27, 2015

(54) CONCEPTS FOR GENERATING AND MANAGING PLANS OF CARE

(71) Applicant: Caradigm USA LLC, Bellevue, WA (US)

(72) Inventors: LINDA WALMER, SEATTLE, WA (US); CATHERINE LAZATIN, CAMBRIDGE, MA (US); CORINNE PASCALE, BELLEVUE, WA (US); CYNTHIA SOWDER, SEATTLE, WA (US); JAMES CONTI, ALGONQUIN, IL (US); DIPTI PATIL, REDMOND, WA (US); KALPANA VISWANATHAN, REDMOND, WA (US); SHAWNA COOPER, REDMOND, WA (US); SIDDHARTH BHATIA, ISSAQUAH, WA (US); SRIDHAR DUTTA, BELLEVUE, WA (US)

(73) Assignee: Caradigm USA LLC, Bellevue, WA (US)

(21) Appl. No.: 14/186,691

(22) Filed: Feb. 21, 2014

(51) Int. Cl. G06F 19/00

(52) U.S. Cl. CPC G06F 19/345; G06F 19/363

(57) ABSTRACT

Computer program products, methods, systems, apparatus, and computing entities are provided for a plan of care. In one embodiment, assessments can be provided. Based on responses to the assessments, various problem, goal, and intervention workflows can be authored onto a patient's plan of care.

### BACKGROUND

Effective management of a patient population (e.g., Care Management) uses a set of evidence-based, integrated clinical care activities that are tailored to the individual patient and that ensure each patient has his or her own coordinated plan of care and services. To achieve this, care managers need an integrated system that allows them to assess patients in a repeatable, consistent way to drive the most effective health and quality of life outcomes.

### BRIEF SUMMARY

In general, embodiments of the present invention provide methods, apparatus, systems, computing devices, computing entities, and/or the like for a plan of care.

In accordance with one aspect, a method for a plan of care is provided. In one embodiment, the method comprises (1) providing an interactive assessment for a patient, the interactive assessment comprising a plurality of sections, each section comprising a plurality of questions to which responses can be provided; (2) receiving a response to at least one of the plurality of questions; (3) determining whether a workflow is associated with the response to the at least one of the plurality of questions; and (4) after determining that a workflow is associated with the response to the at least one of the plurality of questions, providing the workflow for a plan of care for the patient, the workflow comprising one or more goals and one or more interventions.

In accordance with another aspect, a computer program product for a plan of care is provided. The computer program product may comprise at least one computer-readable storage medium having computer-readable program code portions stored therein, the computer-readable program code portions comprising executable portions configured to (1) provide an interactive assessment for a patient, the interactive assessment comprising a plurality of sections, each section comprising a plurality of questions to which responses can be provided; (2) receive a response to at least one of the plurality of questions; (3) determine whether a workflow is associated with the response to the at least one of the plurality of questions; and (4) after determining that a workflow is associated with the response to the at least one of the plurality of questions, provide the workflow for a plan of care for the patient, the workflow comprising one or more goals and one or more interventions.

In accordance with yet another aspect, an apparatus comprising at least one processor and at least one memory including computer program code is provided. In one embodiment, the at least one memory and the computer program code may be configured to, with the processor, cause the apparatus to (1) provide an interactive assessment for a patient, the interactive assessment comprising a plurality of sections, each section comprising a plurality of questions to which responses can be provided; (2) receive a response to at least one of the plurality of questions; (3) determine whether a workflow is associated with the response to the at least one of the plurality of questions; and (4) after determining that a workflow is associated with the response to the at least one of the plurality of questions, provide the workflow for a plan of care for the patient, the workflow comprising one or more goals and one or more interventions.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice embodiments of the present invention.

FIG. 2 is an exemplary schematic diagram of a management computing entity according to one embodiment of the present invention.

FIG. 3 is an exemplary schematic diagram of a care manager computing entity according to one embodiment of the present invention.

FIG. 4 is a flowchart illustrating operations and processes that can be used in accordance with various embodiments of the present invention.

FIGS. 5-38 are exemplary input and output that can be produced from various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. Computer Program Products, Methods, and Computing Entities

Embodiments of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. Exemplary System Architecture

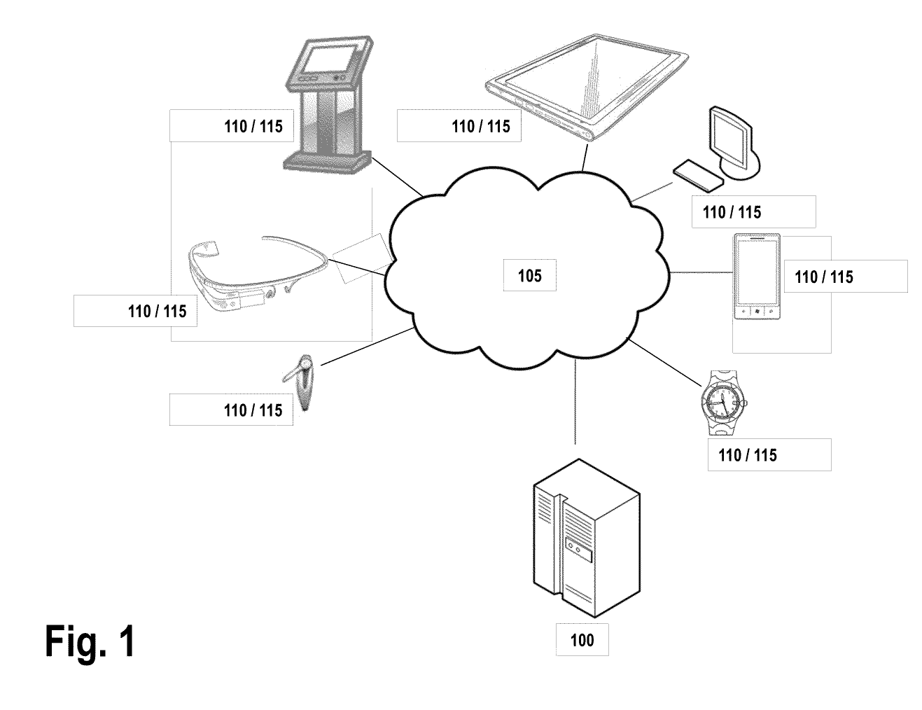

FIG. 1 provides an illustration of an exemplary embodiment of the present invention. As shown in FIG. 1, this particular embodiment may include one or more management computing entities 100, one or more networks 105, one or more care manager computing entities 110, and one or more patient computing entities 115. Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular architecture.

### 1. Management Computing Entity

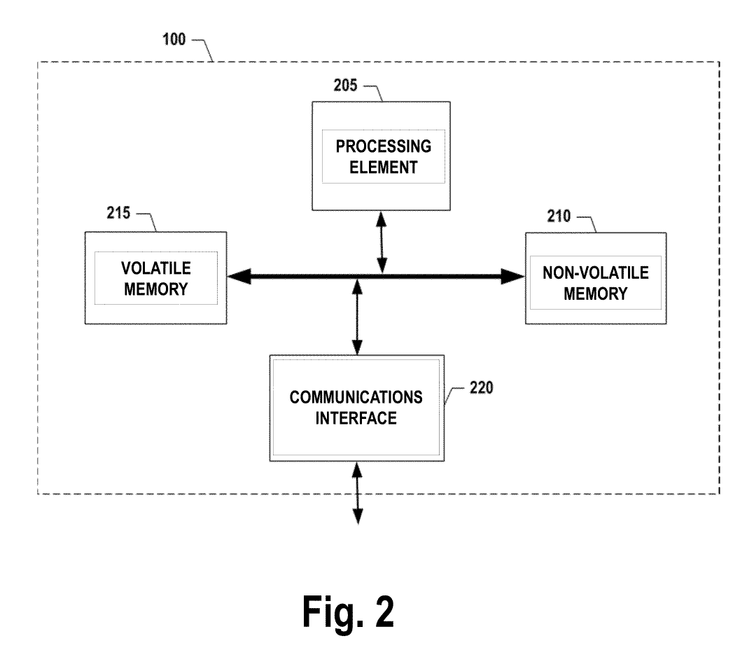

FIG. 2 provides a schematic of a management computing entity 100 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, radio frequency identification (RFID) tags, ear pieces, scanners, televisions, dongles, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the management computing entity 100 may also include one or more communications interfaces 220 for communicating with various computing entities, such as by communicating data, content, information, and/or similar terms used herein interchangeably that can be transmitted, received, operated on, processed, displayed, stored, and/or the like. For instance, the management computing entity 100 may communicate with care manager computing entities 110 and provide functionalities of a plan of care platform.

As shown in FIG. 2, in one embodiment, the management computing entity 100 may include or be in communication with one or more processing elements 205 (also referred to as processors, processing circuitry, and/or similar terms used herein interchangeably) that communicate with other elements within the management computing entity 100 via a bus, for example. As will be understood, the processing element 205 may be embodied in a number of different ways. For example, the processing element 205 may be embodied as one or more complex programmable logic devices (CPLDs), microprocessors, multi-core processors, coproces sing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the management computing entity 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management computing entities, data, applications, programs, program modules, scripts, source code, object code, byte code, compiled code, interpreted code, machine code, executable instructions, and/or the like. Such code may include of a plan of care platform. The terms database, database instance, database management computing entity, and/or similar terms used herein interchangeably may refer to a structured collection of records or data that is stored in a computer-readable storage medium, such as via a relational database, hierarchical database, and/or network database.

In one embodiment, the management computing entity 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management computing entities, data, applications, programs, program modules, scripts, source code, object code, byte code, compiled code, interpreted code, machine code, executable instructions, and/or the like being executed by, for example, the processing element 205. Thus, the databases, database instances, database management computing entities, data, applications, programs, program modules, scripts, source code, object code, byte code, compiled code, interpreted code, machine code, executable instructions, and/or the like may be used to control certain aspects of the operation of the management computing entity 100 with the assistance of the processing element 205 and operating system, such as the of plan of care platform.

As indicated, in one embodiment, the management computing entity 100 may also include one or more communications interfaces 220 for communicating with various computing entities, such as by communicating data, content, information, and/or similar terms used herein interchangeably that can be transmitted, received, operated on, processed, displayed, stored, and/or the like.

Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the management computing entity 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, near field communication (NFC) protocols, Bluetooth™ protocols, wireless universal serial bus (USB) protocols, and/or any other wireless protocol.

Although not shown, the management computing entity 100 may include or be in communication with one or more input elements, such as a keyboard input, a mouse input, a touch screen/display input, motion input, movement input, audio input, pointing device input, joystick input, keypad input, and/or the like. The management computing entity 100 may also include or be in communication with one or more output elements (not shown), such as audio output, video output, screen/display output, motion output, movement output, and/or the like.

As will be appreciated, one or more of the management computing entity's 100 components may be located remotely from other management computing entity 100 components, such as in a distributed system. Furthermore, one or more of the components may be combined and additional components performing functions described herein may be included in the management computing entity 100. Thus, the management computing entity 100 can be adapted to accommodate a variety of needs and circumstances. As will be recognized, these architectures and descriptions are provided for exemplary purposes only and are not limiting to the various embodiments.

### 2. Exemplary Care Manager Computing Entity

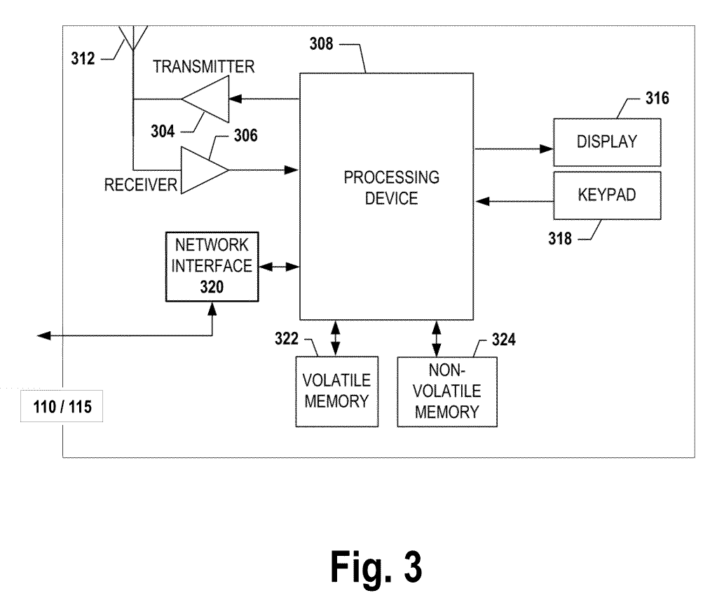

A care manager may be a case manager, a care manager, a health manager, a health liaison, a care associate, pharmacist, medical management representative, a care coordinator, and/or the like associated with or involved in the health care of a patient. A care manager may operate a care manager computing entity 110 that includes one or more components that are functionally similar to those of the management computing entity 100. FIG. 3 provides an illustrative schematic representative of a care manager computing entity 110 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, radio frequency identification (RFID) tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Care manager computing entities 110 can be operated by various parties. As shown in FIG. 3, the care manager computing entity 110 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, respectively.

The signals provided to and received from the transmitter 304 and the receiver 306, respectively, may include signaling information in accordance with air interface standards of applicable wireless systems. In this regard, the care manager computing entity 110 may be capable of operating with one or more air interface standards, communication protocols, modulation types, and access types. More particularly, the care manager computing entity 110 may operate in accordance with any of a number of wireless communication standards and protocols, such as those described above with regard to the management computing entity 100. In a particular embodiment, the care manager computing entity 110 may operate in accordance with multiple wireless communication standards and protocols, such as UMTS, CDMA2000, 1xRTT, WCDMA, TD-SCDMA, LTE, E-UTRAN, EVDO, HSPA, HSDPA, Wi-Fi, WiMAX, UWB, IR, NFC, Bluetooth™, USB, and/or the like. Similarly, the care manager computing entity 110 may operate in accordance with multiple wired communication standards and protocols, such as those described above with regard to the management computing entity 100 via a network interface 320.

Via these communication standards and protocols, the care manager computing entity 110 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The care manager computing entity 110 can also download changes, add-ons, and updates, for instance, to its firmware, software (e.g., including executable instructions, applications, program modules), and operating system.

According to one embodiment, the care manager computing entity 110 may include a location determining aspect, device, module, functionality, and/or similar words used herein interchangeably. For example, the care manager computing entity 110 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information will be determined by triangulating the care manager computing entity's 110 position in connection with a variety of other systems, including cellular towers, Wi-Fi access points, and/or the like. Similarly, the care manager computing entity 110 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, Near Field Communication (NFC) transmitters, and/or the like. These indoor positioning aspects can be used in a variety of settings to determine the location of someone or something to within inches or centimeters.

The care manager computing entity 110 may also comprise a user interface (that can include a display 316 coupled to a processing element 308) and/or a user input interface (coupled to a processing element 308). For example, the user interface may be a care manager application, browser, care manager interface, and/or similar words used herein interchangeably executing on and/or accessible via the care manager computing entity 110 to interact with and/or cause display of information from the management computing entity 100, including the plan of care platform. The care manager input interface can comprise any of a number of devices allowing the care manager computing entity 110 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the care manager computing entity 110 and may include a full set of alphabetic keys or set of keys that may be activated to provide a full set of alphanumeric keys. In addition to providing input, the care manager input interface can be used, for example, to activate or deactivate certain functions, such as screen savers and/or sleep modes.

The care manager computing entity 110 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management computing entities, data, applications, programs, program modules, scripts, source code, object code, byte code, compiled code, interpreted code, machine code, executable instructions, and/or the like to implement the functions of the care manager computing entity 110. As indicated, this may include a care manager application that is resident on the entity or accessible through a browser or other care manager interface for communicating with the plan of care platform of the management computing entity 100 and/or various other computing entities.

In another embodiment, the care manager computing entity 110 may include one or more components or functionality that are the same or similar to those of the management computing entity 100, as described in greater detail above. As will be recognized, these architectures and descriptions are provided for exemplary purposes only and are not limiting to the various embodiments.

### 3. Exemplary Patient Computing Entity

In one embodiment, a patient may operate a patient computing entity 115 that includes one or more components that are functionally similar to those of the management computing entity 100 and/or the care manager computing entity 110. Although the term patient is used, others terms may be used herein interchangeably, including health plan member, user, and/or the like. For example, in one embodiment, each patient computing entity 115 may include one or more processing elements (e.g., CPLDs, microprocessors, multi-core processors, coprocessing entities, ASIPs, microcontrollers, and/or controllers), one or more display device/input devices (e.g., including user interfaces), volatile and non-volatile storage or memory, and/or one or more communications interfaces. For example, the user interface may be a patient application, browser, patient interface, and/or similar words used herein interchangeably executing on and/or accessible via the patient computing entity 115 to interact with and/or cause display of information from the management computing entity 100, including the plan of care platform. This may also enable the patient computing entity 115 to communicate with various other computing entities, such as care manager computing entities 110, and/or various other computing entities. As will be recognized, these architectures and descriptions are provided for exemplary purposes only and are not limiting to the various embodiments.

### III. Exemplary System Operation

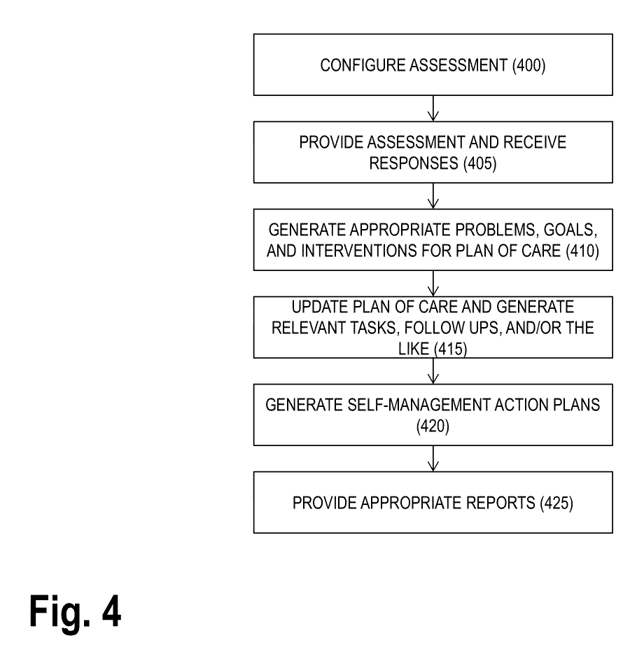

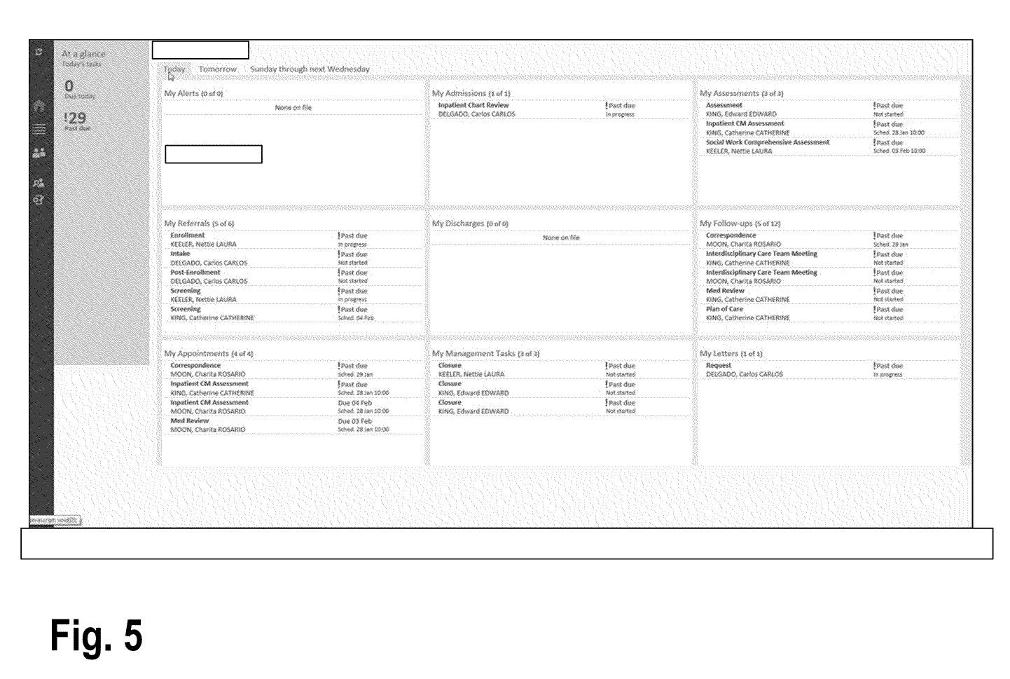

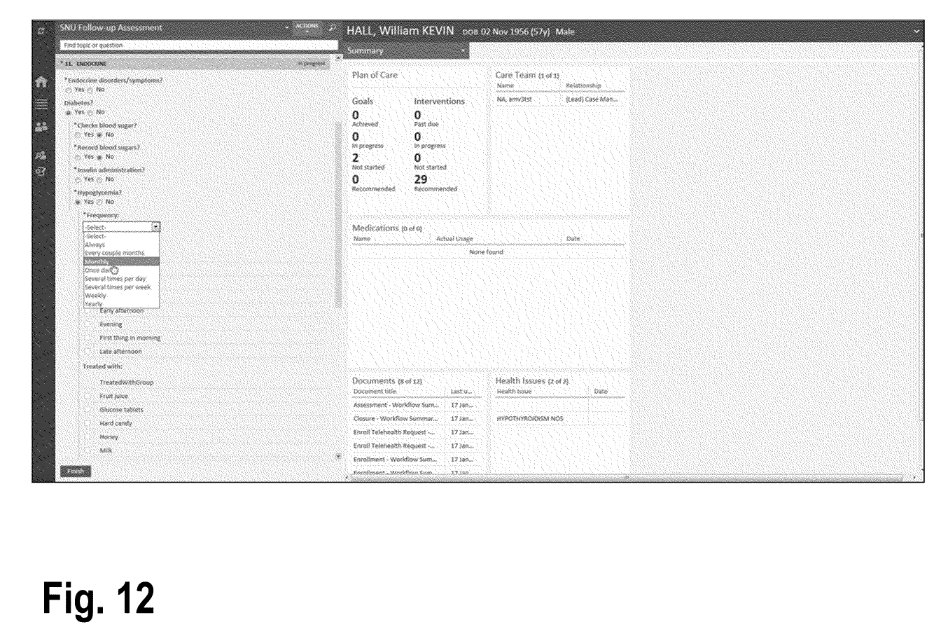

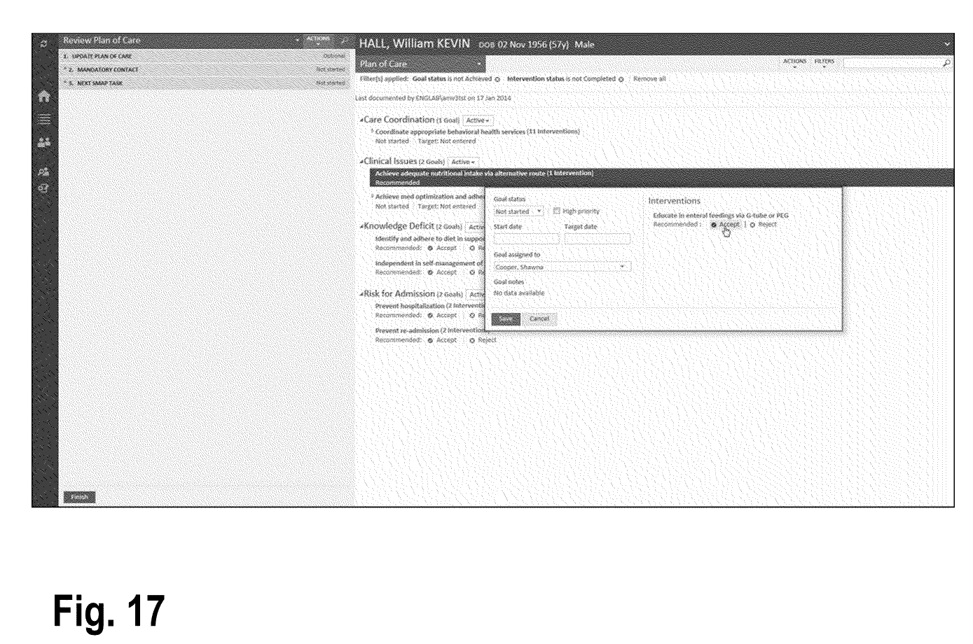

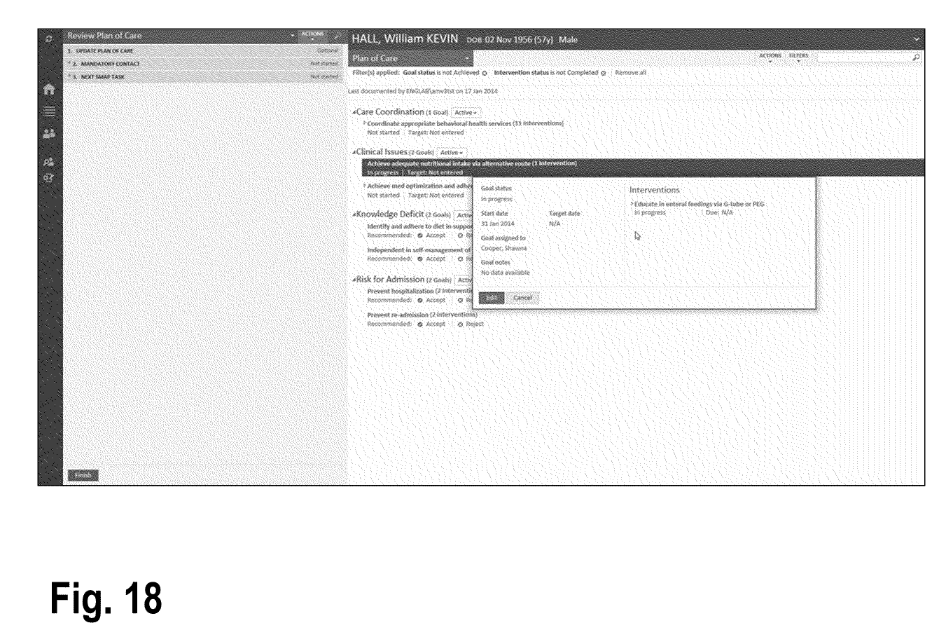

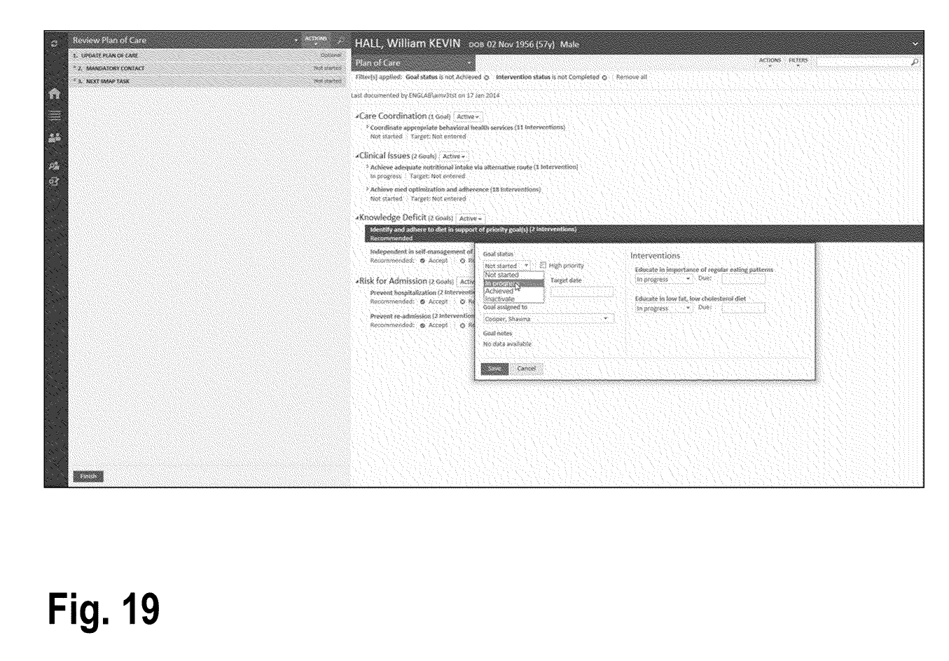

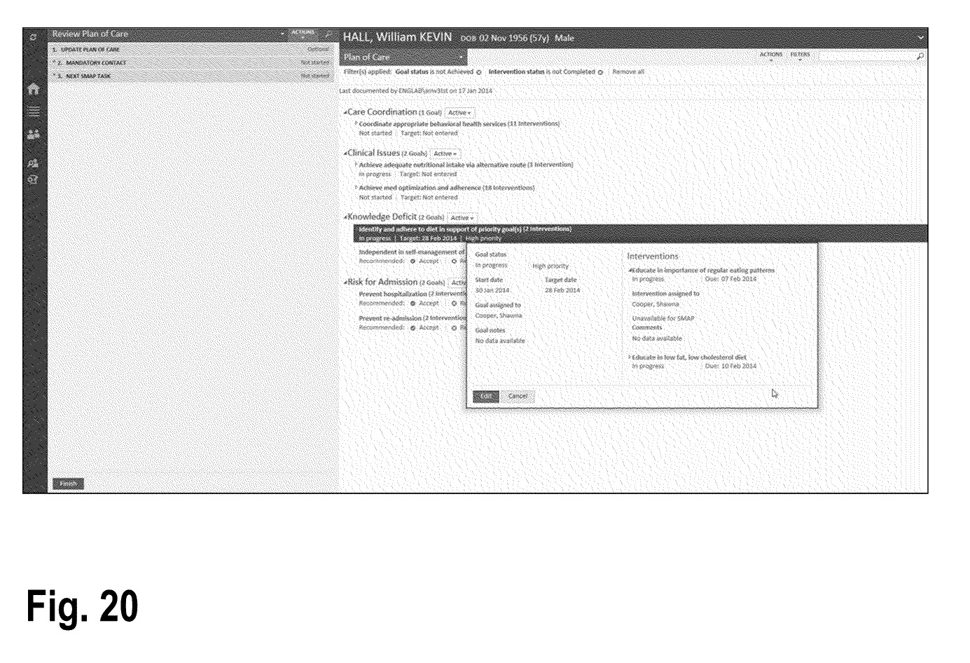

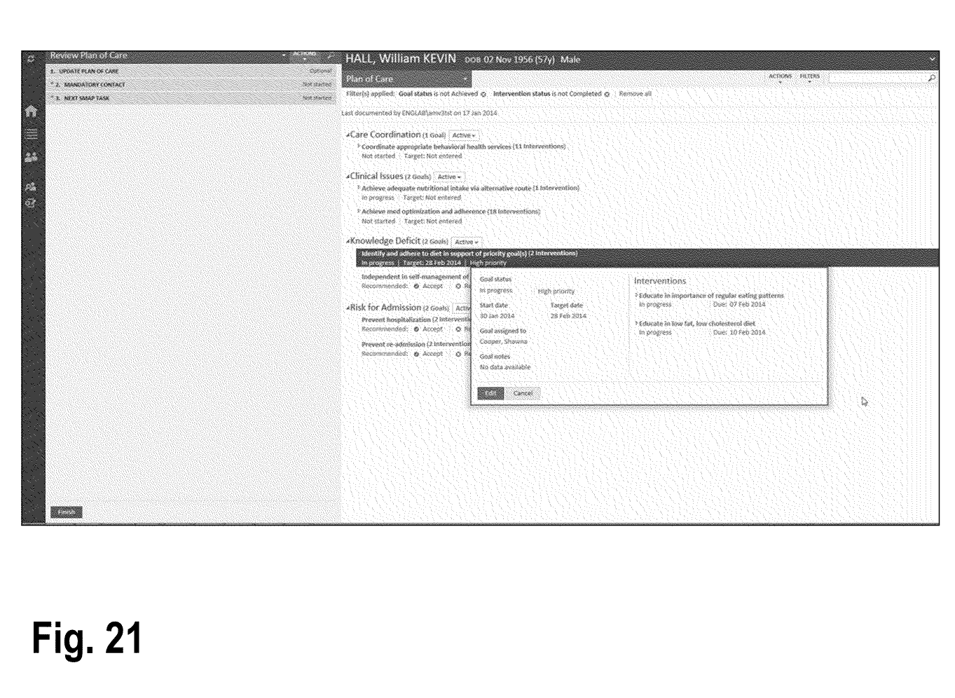

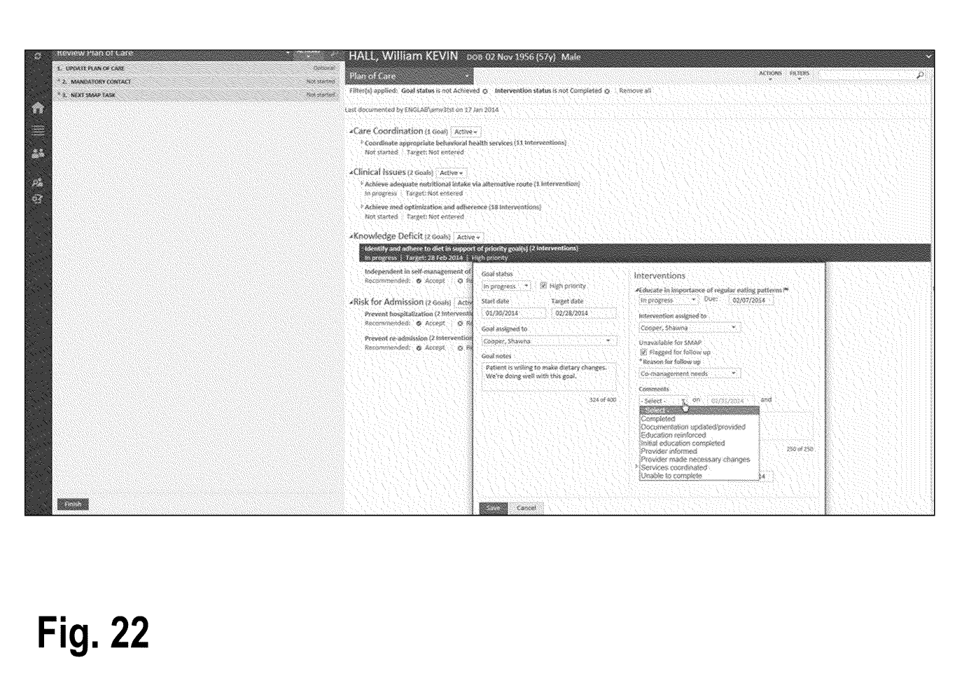

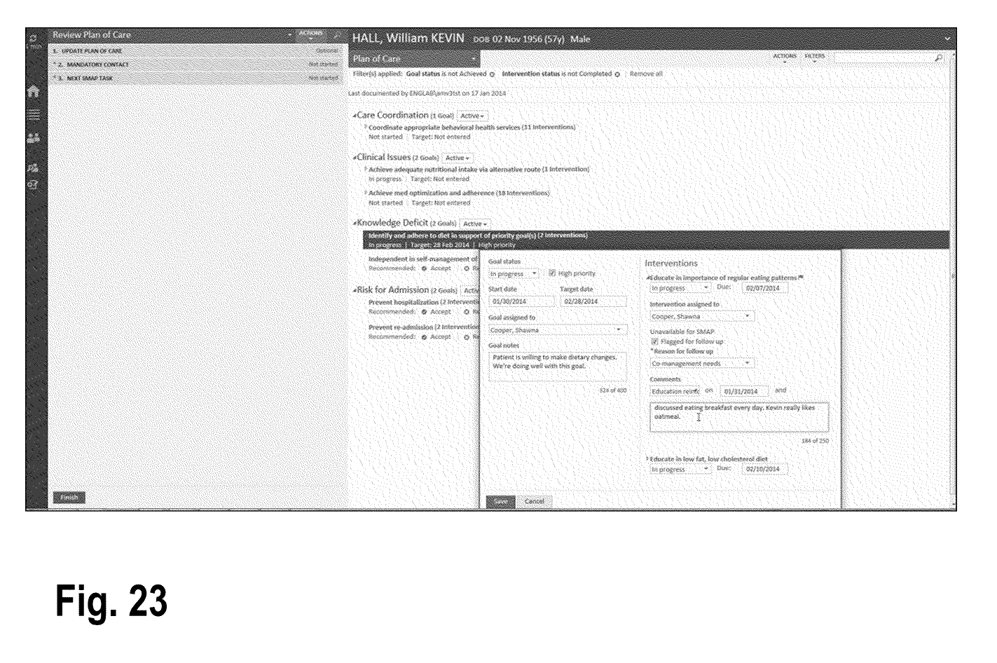

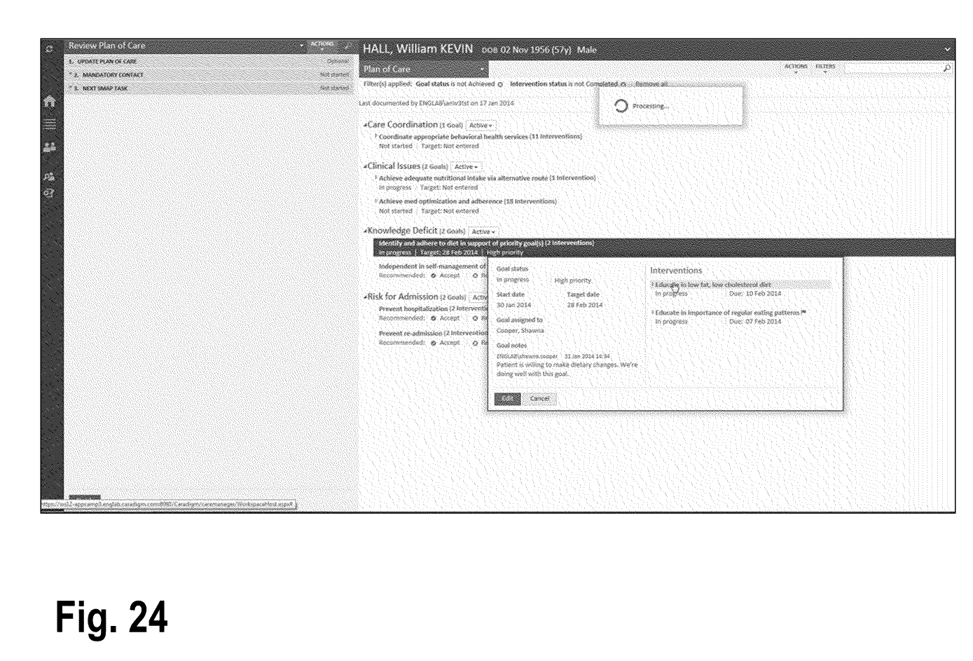

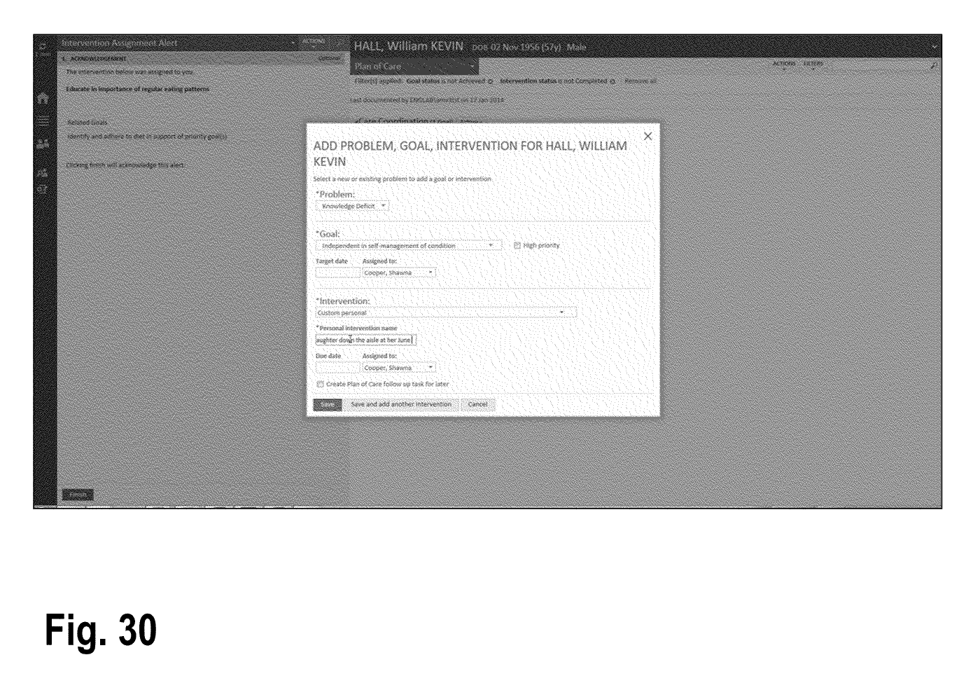

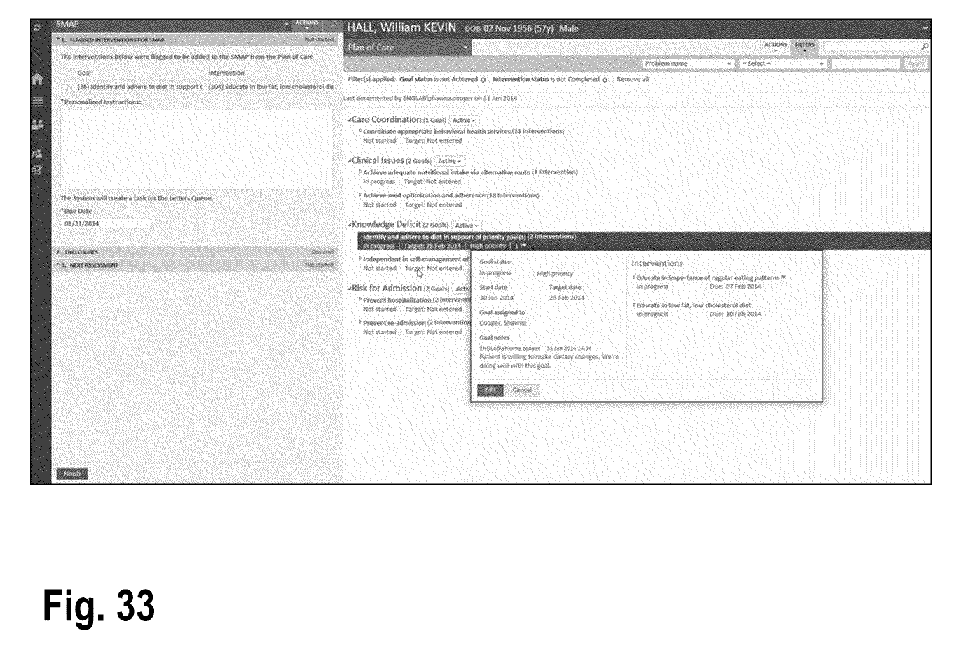

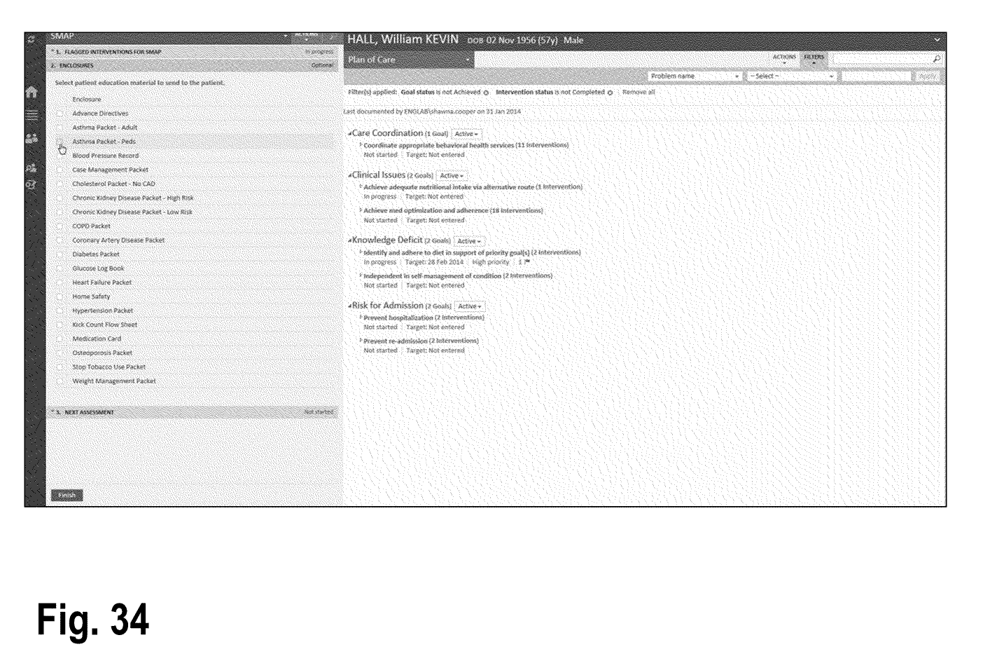

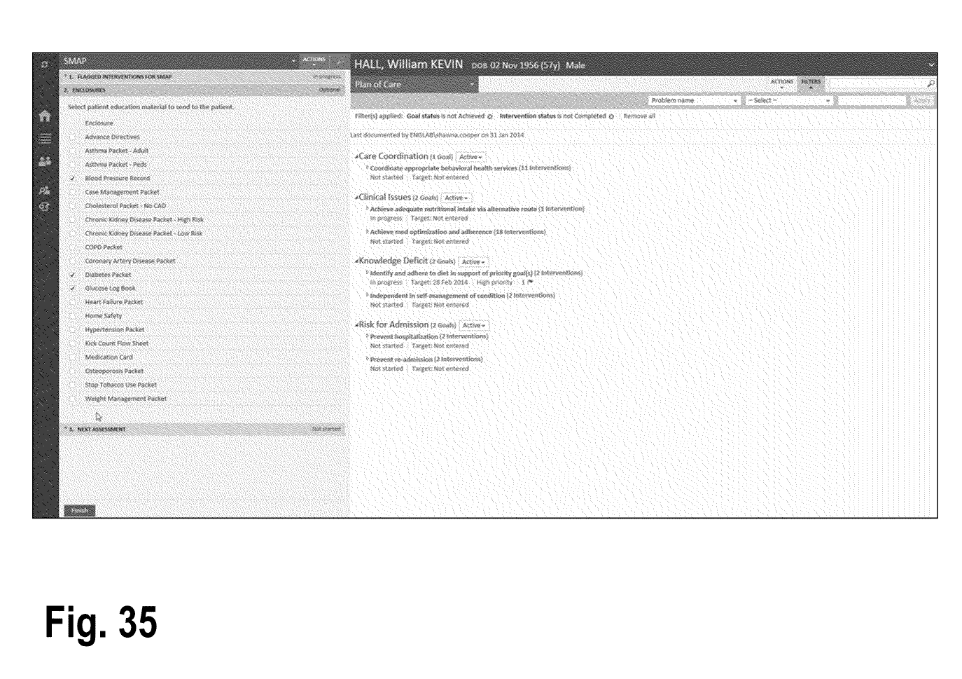

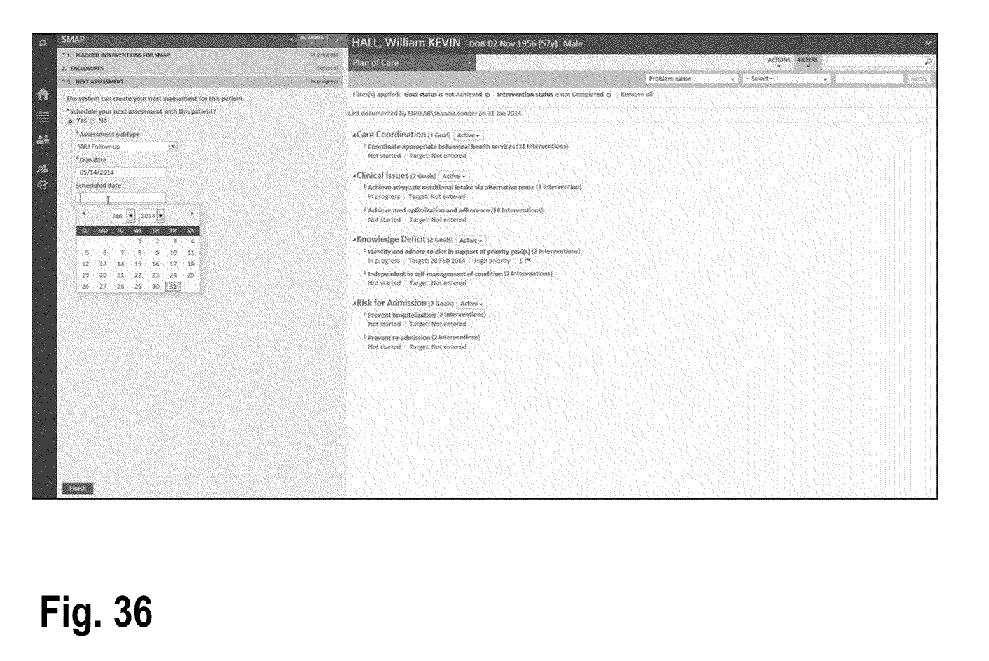

Reference will now be made to FIGS. 4-38. FIG. 4 is a flowchart illustrating operations and processes that may be performed for a plan of care platform. FIGS. 5-38 are exemplary input and output that can be produced from various embodiments of the present invention.

Embodiments of the present invention relate to creating/generating and managing one or more plans of care of a patient. A plan of care may comprise or indicate (a) services a patient needs, (b) problems the patient is facing, (c) goals for overcoming the problems or achieving desired health-related results, (d) tasks for completing the goals, (e) tasks or schedules for following up with or monitoring the patient, (f) who should assist the patient in obtaining the needed services or achieving the desired goals, (g) what equipment is needed for the patient, and/or the like. In one embodiment, the process may begin once a need for care management services is identified for a particular patient. After identifying a particular need for a patient, a care manager can intake information for the patient, screen the patient, and enroll the patient in any appropriate programs. A care manager (e.g., operating a care manager computing entity 110) can then assess the patient on an individual basis using one or more assessments. As will be described in greater detail below, an assessment may include one or more topics/sections, with each topic/section comprising one or more questions (oftentimes conditional) pertaining to the enrolled program and/or needs of the patient. For a given assessment, the responses to questions may trigger/initiate authoring, creating/generating, linking, establishing, assigning, and/or similar words used herein interchangeably one or more recommended problem, goal, and intervention (PGI) workflows onto a plan of care for a patient. It is a workflow in the sense that a PGI workflow includes one or more problems, one or more goals for overcoming or addressing the problem, and one or more interventions for achieving the goals that can be used to create tasks for the care manager and/or patient. The term workflow may be used to refer to any part of the PGI workflow (collectively or individually): one or more problems, one or more goals, one or more interventions, and/or combinations thereof. Then, the care manager can manage the patient's plan of care (e.g., comprising one or more PGI workflows) and engage the patient in one or more self-management action plans (SMAPs).

### 1. Patients and Patient Information/Data

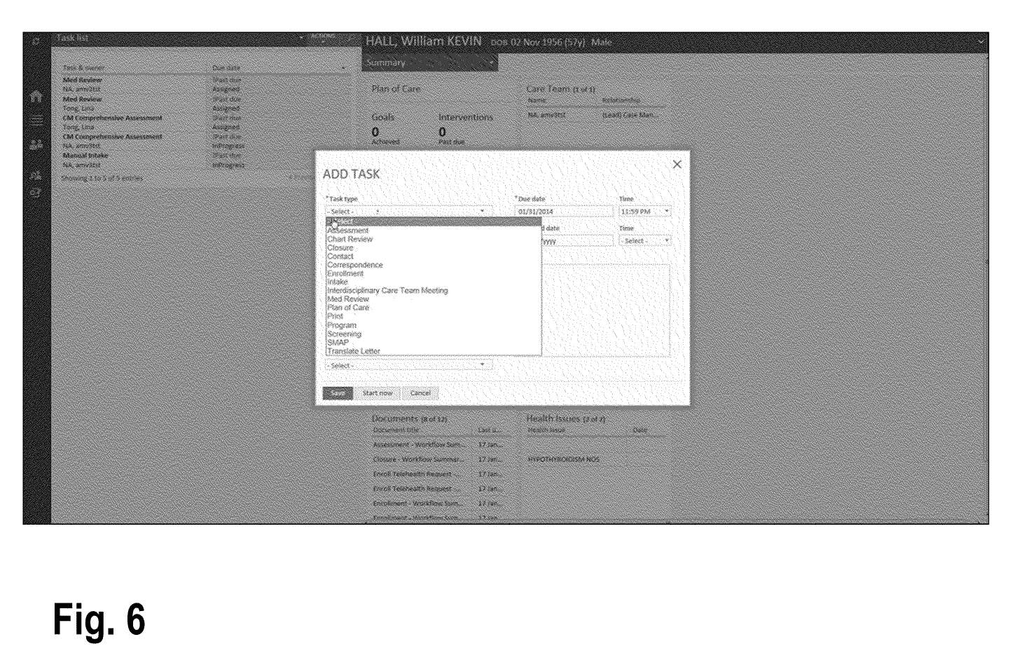

In one embodiment, the management computing entity 100 (executing the plan of care platform) may store or otherwise have access to patient information/data for patients, which may comprise electronic medical records (EMRs). The patient information/data may comprise a patient's biographic information, such as name, birthdate, age, social security number, addresses, phone numbers, email addresses, and/or the like. The patient information/data may also comprise a patient's weight, height, medical record number, patient or member number, allergies, symptoms, medical conditions, and/or the like. The patient information/data may also comprise one or more plans of care (including PGI workflows). The patient information/data may also comprise information/data regarding the patient's surgeries, claims, medical providers, schedules, treatments, care pathways, care programs, medical history, insurance information, payment information, family history, and/or the like. By way of example, FIG. 5 shows a user interface (e.g., a care manager application, browser, or interface executing on a care manager computing entity 110 in communication with the plan of care platform of the management computing entity 100) causing display of patient information/data for a patient named William Kevin Hall. As shown in this FIG. 6, Mr. Hall was born on Nov. 2, 1956, and is male. As will be recognized, a variety of patient information/data can be displayed to adapt to various needs and circumstances.

In one embodiment, through the care manager application, browser, or care manager interface executing on a care manager computing entity 110, a care manager can create/generate, manage, update, modify, and similar words used herein interchangeably a plan of care (including PGI workflows) for a patient. The plan of care (including PGI workflows) can be stored in association with the patient information/data.

### 2. Care Manager Profiles

As previously indicated, a care manager may be a case manager, a care manager, a health manager, a health liaison, a care associate, a care coordinator, a medical provider, pharmacist, medical management representative, and/or the like associated with or involved in the health care of a patient. Each of these different types of care managers may have (a) different access rights, (b) different abilities to perform assessments, (c) different abilities to assign tasks to other care managers or patients, (d) different abilities to modify assessments, topics/sections, questions, PGI workflows, plans of care, (e) different abilities to access or manage plans of care, (f) access to or be provided with different assessments or sets of assessments, and/or the like. Given the potentially different rights, privileges, and abilities, the management computing entity 100 may store care manager profiles that correspond respectively to different care managers. A care manager profile may include the care manager's attributes, such as (a) username to access the management computing entity 100, (b) password to access the management computing entity 100, (c) employee identification number, (d) name, (e) email addresses, (f) SMS addresses, (g) phone numbers, (h) residential address, (i) primary skill, (j) work/job class, (k) seniority date, (l) birthday, (m) languages spoken, (n) certifications or licenses, (o) schedule preferences, (p) role, and/or the like.

In one embodiment, care managers have corresponding profiles for accessing, using, and/or interacting with the plan of care platform of the management computing entity 100. As noted, the different care manager profiles may be associated with (a) different access rights, (b) different abilities to perform assessments, (c) different abilities to assign tasks to other care managers or patients, (d) different abilities to modify assessments, topics/sections, questions, PGI workflows, plans of care, (e) different abilities to access or manage plans of care, (f) access to or be provided with different assessments or sets of assessments, and/or the like. Moreover, a care manager profile can be used by a care manager (e.g., operating a care manager computing entity 110) (a) to view his or her assigned tasks, (b) to view tasks assigned to other care managers, (c) to track, monitor, and/or record information/data about patients, and/or the like. The types of profiles and their corresponding access and rights may vary and be customized to suit a variety of needs and circumstances.

### 3. Assessments

In one embodiment, with the appropriate credentials, a care manager (e.g., operating a care manager computing entity 110) can access the plan of care platform executing on the management computing entity 100 to create, access, modify, and/or manage various plans of care. FIG. 5 shows an illustrative landing page or home page for a care manager (e.g., operating a care manager computing entity 110) upon providing the appropriate credentials and/or navigating to the appropriate area of the interface. As can be seen from this figure, the interface (e.g., displayed via the care manager computing entity 110 in communication with the management computing entity 100) can cause display of the care manager's tasks due today, tasks past due, alerts, recent admissions of patients under his or her care, recent discharges of patients under his or her care, assessments that require action or need to be completed, referrals, follow-ups related to plans of care, appointments and other calendar functions, various management tasks, letters or materials to be completed or sent out, assigned interventions, review plans of care, follow-up plans of care (e.g., flagging a particular intervention for follow up), create or review SMAPs, and/or the like. At least some of the items displayed via the interface (e.g., via the care manager computing entity 110 in communication with the management computing entity 100) can result from interactive assessments as is described below.

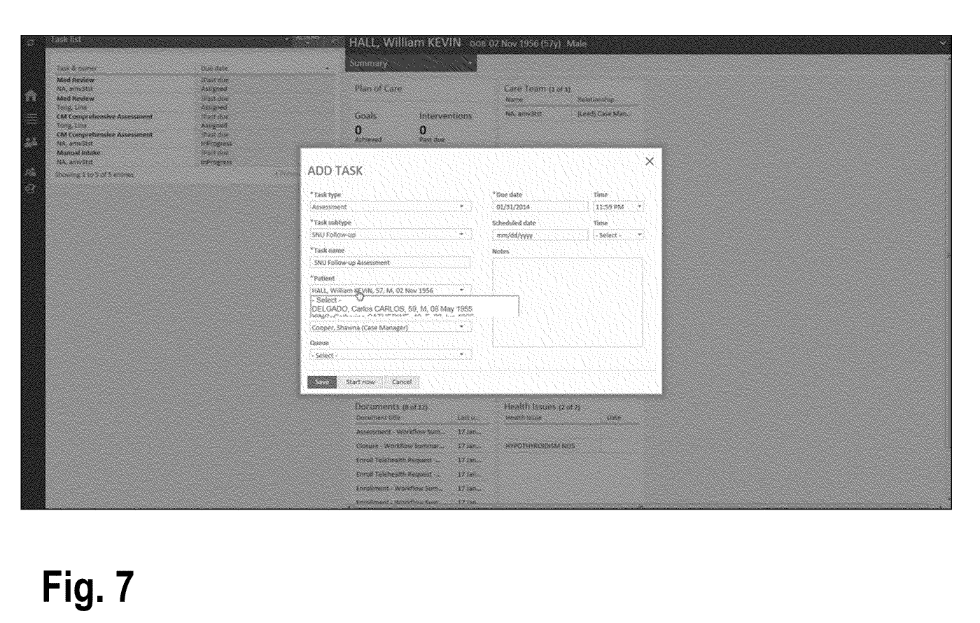

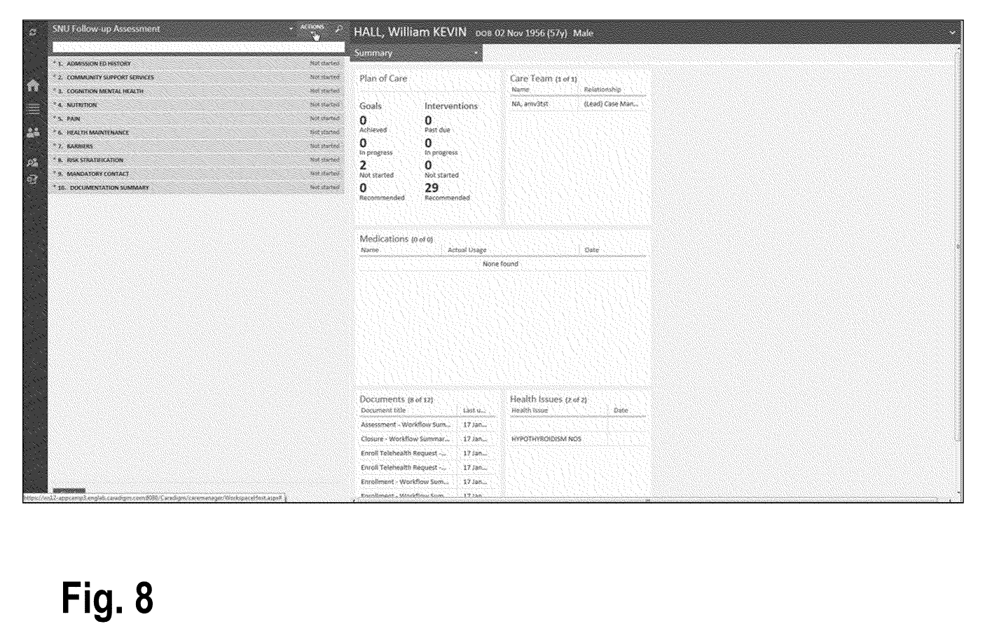

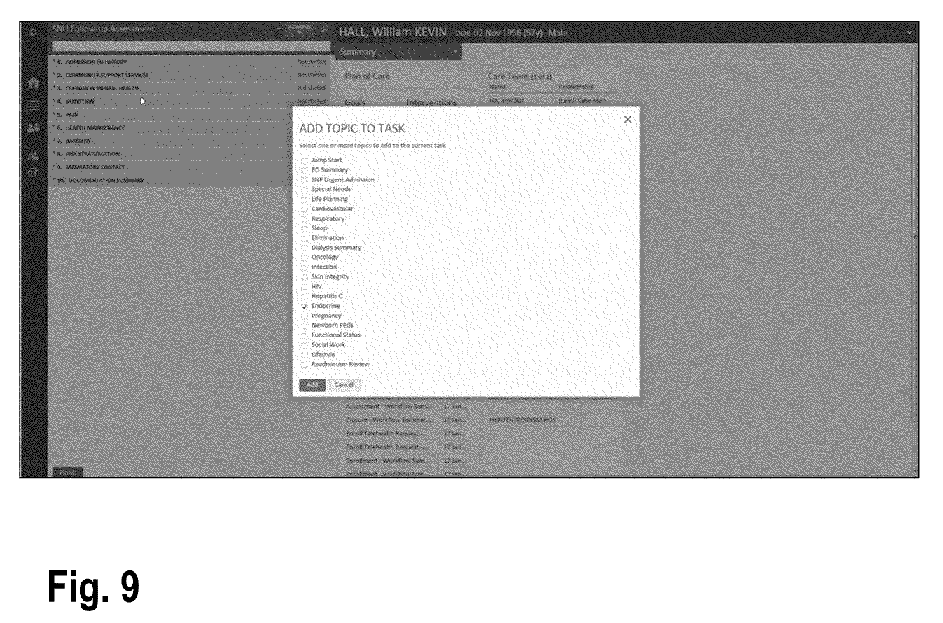

FIGS. 6 and 7 show a single patient view (for William Kevin Hall) from which one or more interactive assessments can be configured (e.g., created/generated, accessed, modified, and/or managed) and/or executed/provided (Blocks 400 and 405 of FIG. 4). As shown in these figures, the task type of “assessment” can be selected from the dropdown menu along with a task subtype, task name, corresponding patient and care manager, queue, due date and time, scheduled date and time and any notes. Interactive assessments may be electronic forms, questionnaires, surveys, and/or similar words used herein interchangeably. Each interactive assessment may comprise one or more hierarchical topics/sections with conditional logic (with potentially one or more hierarchical subtopics or subsections within each topic/section). FIG. 8 shows an exemplary predefined “SNU Follow-Up Assessment” with ten predefined topics/sections. In this example, the ten predefined topics/sections are: 1. ADMISSION ED HISTORY, 2. COMMUNITY SUPPORT SERVICES, 3. COGNITION MENTAL HEALTH, 4. NUTRITION, 5. PAIN, 6. HEALTH MAINTENANCE, 7. BARRIERS, 8. RISK STRATIFICATION, 9. MANDATORY CONTACT, and 10. DOCUMENTATION SUMMARY. As noted, although this particular assessment is predefined, it can be modified—e.g., topics/sections can be added or removed. To do so, each unique topic/section may have a unique name and be associated with a unique topic/section identifier (e.g., a unique character string). For instance, FIG. 9 shows a care manager (e.g., operating a care manager computing entity 110) adding an Endocrine topic/section (e.g., topic/section TS1HZ43R) to the assessment by selecting the Endocrine topic/section from a content library (assessments, topics/sections, and/or questions are also referred to herein as content). The content library helps to standardize care by allowing the same assessments, topics/sections, and/or questions to be used for patients in similar situations—e.g., candidates for diabetes can all be asked the same questions from the Endocrine topic/section. As will be recognized, any of the other topics/sections can be added from the content library as well. Moreover, new topics/sections can also be created/generated to adapt to various needs and circumstances. This enables predefined assessments to be modular in that topics/sections can be added and/or removed as desired to customize assessments. Assessments, topics/sections, and/or questions can also be searched. For example, a search for the word “diabetes” can be used to identify all assessments, topics/sections, and/or questions that include or are related to the word fall.

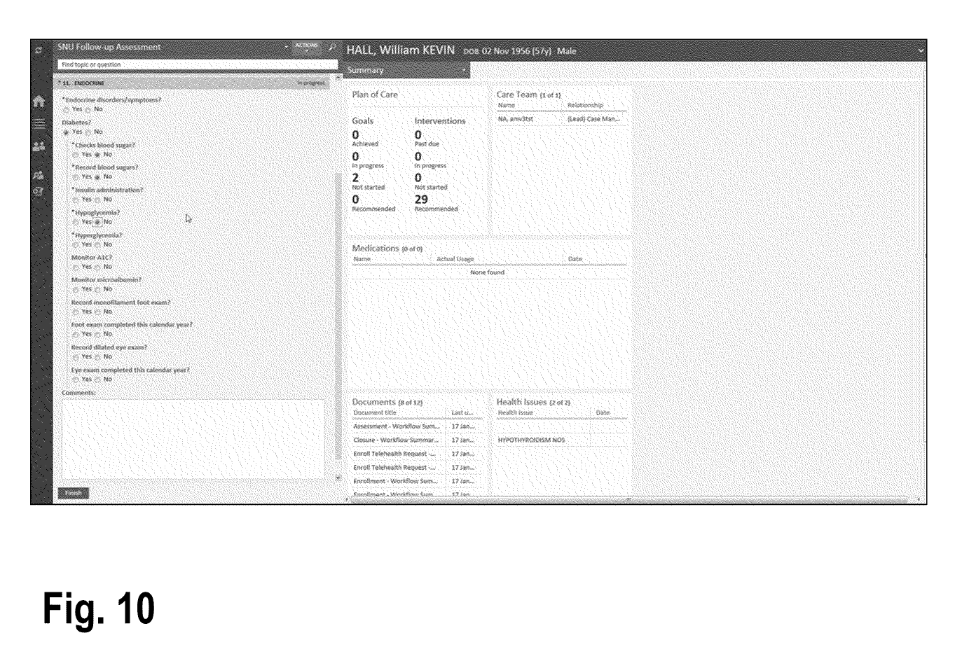

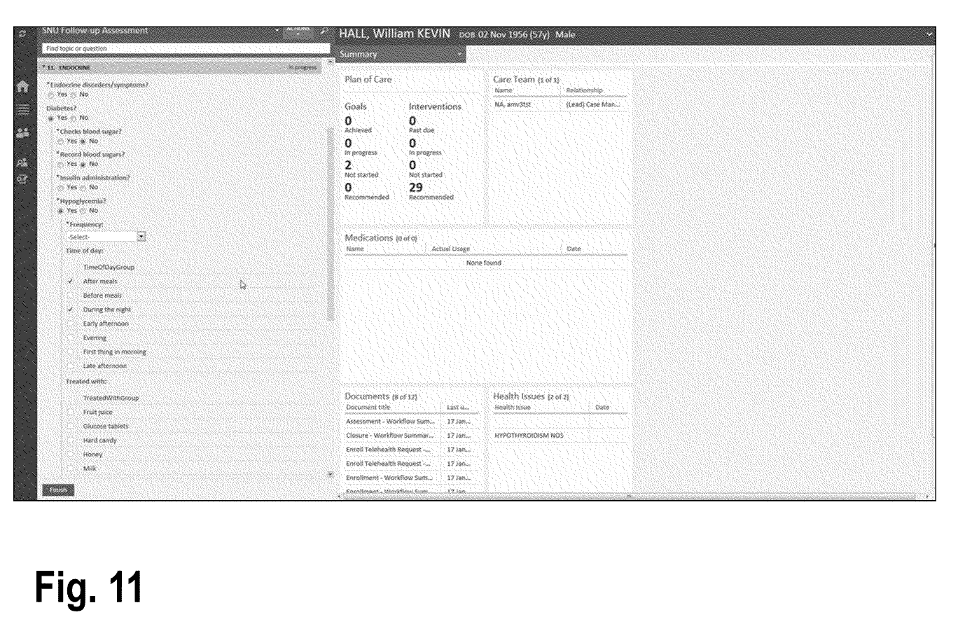

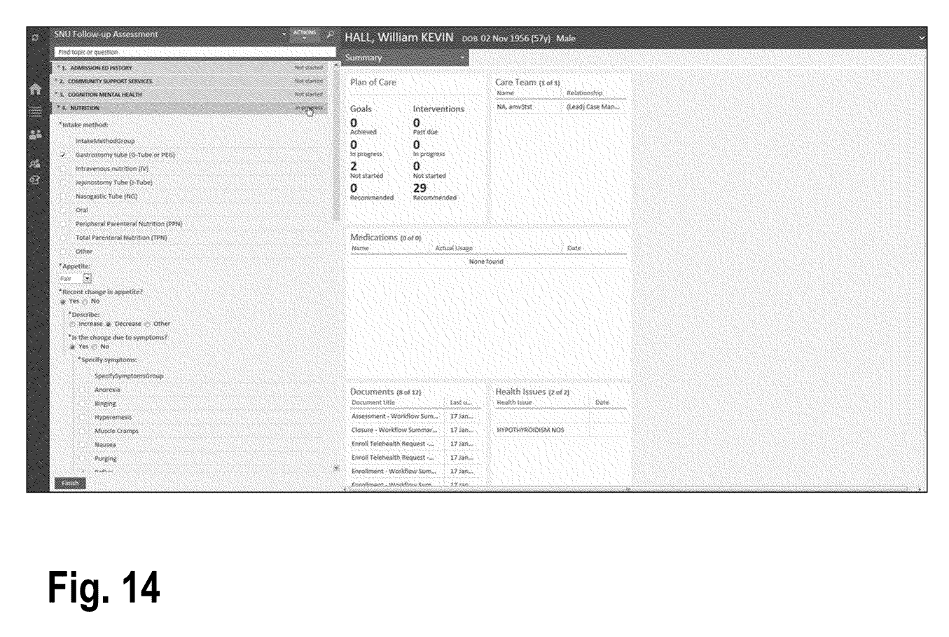

As will be recognized, each topic/section can comprise one or more hierarchical questions with conditional logic. As shown in FIG. 10, the care manager computing entity 110 causes display of two primary questions—(1) Endocrine disorders/symptoms? and (2) Diabetes?—with several nested questions that are only displayed if the response to the diabetes questions is “yes.” In response to a “yes” to the diabetes question, the care manager computing entity 110 (in communication with the plan of care platform of the management computing entity 110) can cause display of the nested/hierarchical questions based on the conditional logic. FIG. 11 shows even further nested questions that can be displayed by the care manager computing entity 110 (in communication with the management computing entity 100) in response to receiving triggering responses based on conditional logic. Thus, the questions can be hierarchical and comprise conditional logic to cause display of additional nested/hierarchical questions as part of a topic/section. Further, the management computing entity 100 can also dynamically create or provide questions as part of an interactive assessment based on a variety of factors, such as a patient's demographic information/data, clinical information/data, family history information/data, and/or the like. For example, the management computing entity 100 might only cause display of questions in a topic/section related to a specific gender, such as only presenting pregnancy or pap smear questions to female patients. As will be recognized, a variety of other options can be used as well. As another example, FIG. 14 shows an exemplary Nutrition topic/section.

In one embodiment, the questions may be specific to the topic/section with which they are associated. As with each topic/section, each unique question may be associated with a unique topic/section identifier (e.g., a unique character string). For instance, FIG. 10 shows a plurality of questions: each of these questions can be associated with a unique question identifier (e.g., question Q185D). The questions can also be stored in the content library and in association with topics/sections and/or assessments. For example, when creating/generating a new topic/section or assessment, a care manager (e.g., operating a care manager computing entity 110) can add questions to an existing assessment or topic/section by selecting questions from the content library. Moreover, one or more questions under a given topic/section may allow for documenting by exception. For instance, the management computing entity 100 may allow for a care manager (e.g., operating a care manager computing entity 110) to mark an entire topic/section or set of questions as not relevant. This would allow the care manager (e.g., operating a care manager computing entity 110) to provide an appropriate input (e.g., topic/section or other level checkbox) to bypass or skip the corresponding topic/section and/or questions. The care manager (e.g., operating a care manager computing entity 110) can also add and/or remove questions from the content library to adapt various needs and circumstances. As with the assessments, this enables predefined topics/sections to be modular in that questions can be added and/or removed as desired.

In one embodiment, if a predefined assessment is modified or a new assessment is created/generated, the modified or new assessment can be saved in the content library as a predefined assessment that can be reused. The content library may comprise any number of assessments, topics/sections, and/or questions. Thus, similar to topics/sections and/or questions, each unique assessment may have a unique name and/or be associated with a unique assessment identifier (e.g., a unique character string, such as A11RE4). As with the above, a care manager (e.g., operating a care manager computing entity 110) or other user with appropriate credentials can create/generate one or more assessments to be provided by adding one or more topics/sections to an assessment template.

Continuing with the previous example, FIGS. 10-13 show the SNU Follow-Up Assessment being executed with responses to the Endocrine topic/section being provided (e.g., via a care manager operating a care manager computing entity 110). As will be recognized, responses to questions can be provided by various parties, including care managers (e.g., operating care manager computing entities 110), patients (e.g., operating patient computing entities 115), or a patient's advocate or family. For each response received, the management computing 110 can store the responses for the patient in association with the appropriate unique question identifiers. For instance, the management computing entity 110 can store each response ever provided for the question associated with question identifier Q185D, irrespective of the topic/section or assessment from which the responses were provided. Thus, for example, if the question associated with question identifier Q185D was responded to in 2014 under the Endocrine section and in 2016 under the nutrition topic/section, the management computing entity would store both responses in association with the corresponding patient's information/data and the question identifier Q185D. Accordingly, if a question is included in multiple topics/sections or assessments, the management computing entity 110 can provide previous responses for a given answer to the question (even if the question was answered in a different assessment), for example, to see if the patient's responses have changed over time or if they are currently accurate, when the question was last answered, what assessment was provided when the question last answered, and who answered the question last, and/or the like. The management computing entity 100 can also do the same for topics/sections and/or assessments to track a patient's previous responses for the same.

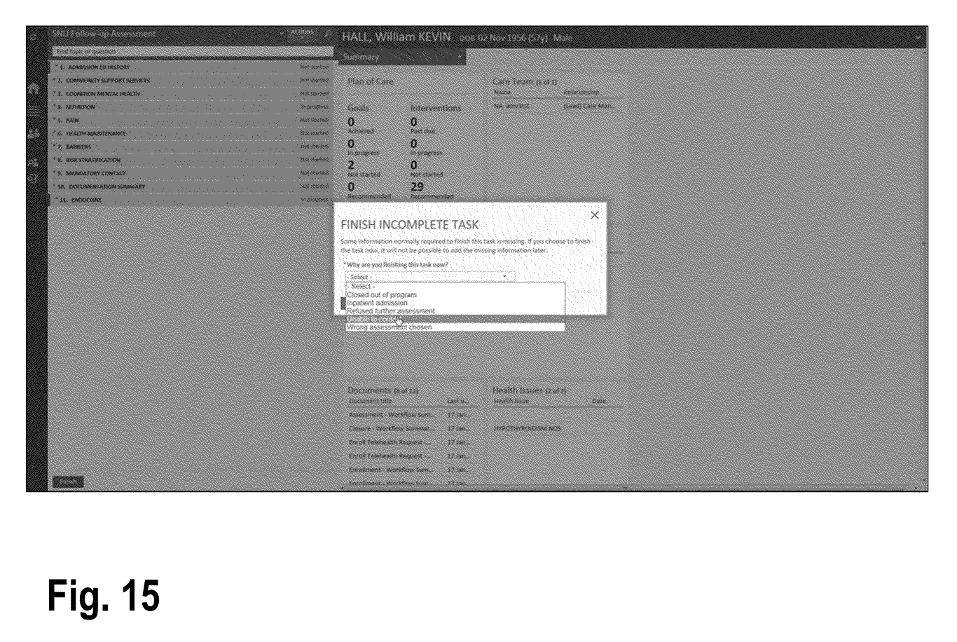

In one embodiment, there may be questions that require responses before a topic/section is considered complete (in addition to optional questions). Moreover, there may be topics/sections or portions thereof that require responses for an assessment to be considered complete (in addition to optional topics/sections). To ensure the completeness of a question, topic/section, and/or assessment, the management computing entity 110 can impose validation logic in a variety of circumstances. For example, before allowing a user (e.g., care manager) to move to a different topic/section, the management computing entity 110 can execute validation logic on the corresponding questions for the current topic/section to ensure that the topic/section as completed as desired. Similarly, the management computing entity 110 can also execute the validation logic when an assessment is saved, closed, exited, and/or the like (see FIG. 15). In certain embodiments, the management computing entity 100 can also provide a “force finish” feature that allows required questions to be bypassed, but still creates/generates PGI workflows for any completed questions. To use the force finish feature, the management computing entity 100 may require the use to enter the reason for the forced finish and store the same. As will be recognized, a variety other approaches and techniques can be used to adapt to various needs and circumstances.

In operation, a care manager (e.g., operating a care manager computing entity 110) can access, create/generate, and/or modify one or more assessments for a patient. The management computing entity 110 can execute/provide the corresponding assessment (Block 405 of FIG. 5) by causing display (e.g., via an appropriate computing entity) of the assessment and receiving responses thereto. As part of providing or executing the assessment, the care manager computing entity 110 can interactively cause display of the assessment, the different topics/sections, and/or questions. In response, the care manager (e.g., operating a care manager computing entity 110) can provide responses to the questions based on knowledge, responses, and/or feedback from the patient (Mr. Hall in this example). In other embodiments, other parties can use the interactive assessment, including patients (e.g., operating patient computing entities 115). The management computing entity 100 can store responses to the assessments, topics/sections, and/or questions (including the corresponding unique identifiers) in association with patient information/data for the patient. In one embodiment, the responses can be saved and stored in a “pencil state” as an assessment progresses (e.g., the management computing entity 100 storing responses as they are input)—automatically saving the care manager's responses to each assessment question as the user moves through the assessment, without requiring the care manager to press a “save” button and/or the like. In one embodiment, this may allow for sharing the pencil state between care managers in the case of transfer cases, co-management, and/or the like. Further, the management computing entity 100 can also store the fully completed in assessments in a variety of formats. For example, the information/data from a full assessment can be saved in a portable document format (PDF), a Word format, an Open Document Format (ODF), and/or the like to allow both the questions and responses to be provided in a searchable and reportable manner. As will be recognized, a variety of other approaches and techniques can be used to adapt to various needs and circumstances.

### 4. Plans of Care and Problems, Goals, and Interventions

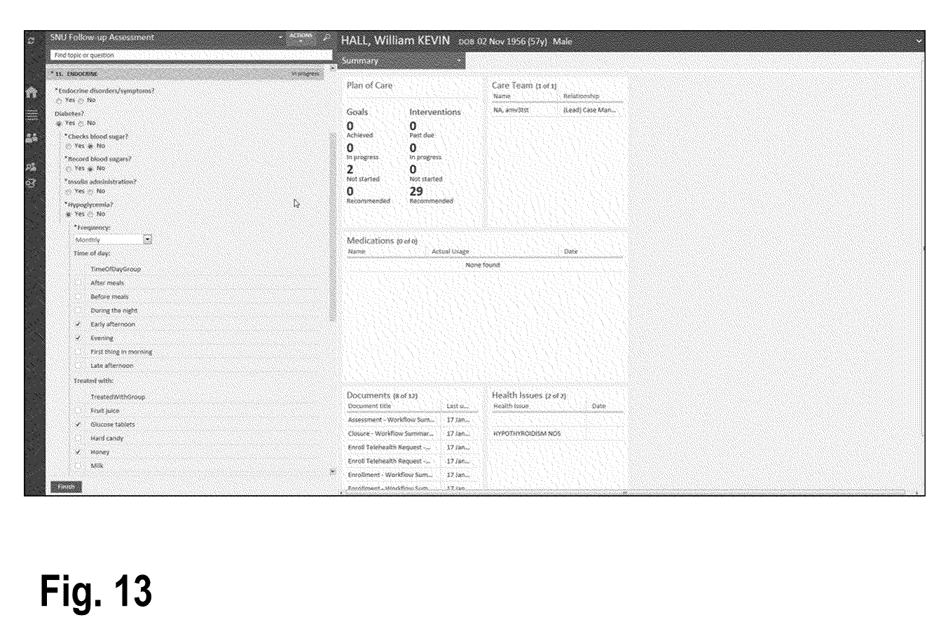

In one embodiment, for a given assessment or topic/section, the responses to questions can be configured to trigger/initiate authoring, creating/generating, linking, establishing, or assigning one or more PGI workflows onto a plan of care for a patient (Block 410 of FIG. 4). As previously described, a plan of care may comprise or indicate (a) services a patient needs, (b) problems the patient is facing, (c) goals for overcoming the problems or achieving desired health-related results, (d) tasks for completing the goals, (e) tasks or schedules for following up with or monitoring the patient, (f) who should assist the patient in obtaining the needed services or achieving the desired goals, (g) what equipment is needed for the patient, (h) one or more PGI workflows and/or the like. A PGI workflow may comprise one or more problem (e.g., identified based on the one or more response provided in the assessment), goal (e.g., one or more objectives to overcome, combat, minimize, reduce risk from and/or the likelihood of the problem), and intervention (e.g., one or more tasks to help accomplish the one or more objectives) workflows. Each PGI workflow may be associated with (e.g., mapped to) one or more triggering responses to specific questions. For example, as shown in FIG. 13, the question “Checks blood sugar?” question may trigger a PGI workflow for a response indicating “no,” but might not be associated with a PGI workflow for a response indicating “yes.” Further, in one embodiment, regardless of the assessment or topic/section in which the PGI workflow is used, the PGI workflow can be linked or associated with a question and can be triggered/initiated based on a specific response. Each PGI workflow can also be associated with other triggering/initiating criteria, such as gender, age, weight, and/or the like. For instance, certain PGI workflows associated with patients may only be relevant to males or females, people who are overweight, or under the age of 40. Thus, the management computing entity 100 can also use such criteria to determine whether a given PGI workflow should be trigger/initiated. Moreover, the PGI workflow and/or each problem, goal, and/or intervention may be stored in association with a unique identifier (e.g., PGI workflow identifier, problem identifier, goal identifier, and/or intervention identifier). As with assessments, topics/sections, and/or questions, PGI workflows and their mappings can be removed, added, modified, and/or the like to adapt to various needs and circumstances. Moreover, the associations (e.g., mappings) to the various questions can also be removed, added, modified, and/or the like to adapt to various needs and circumstances.

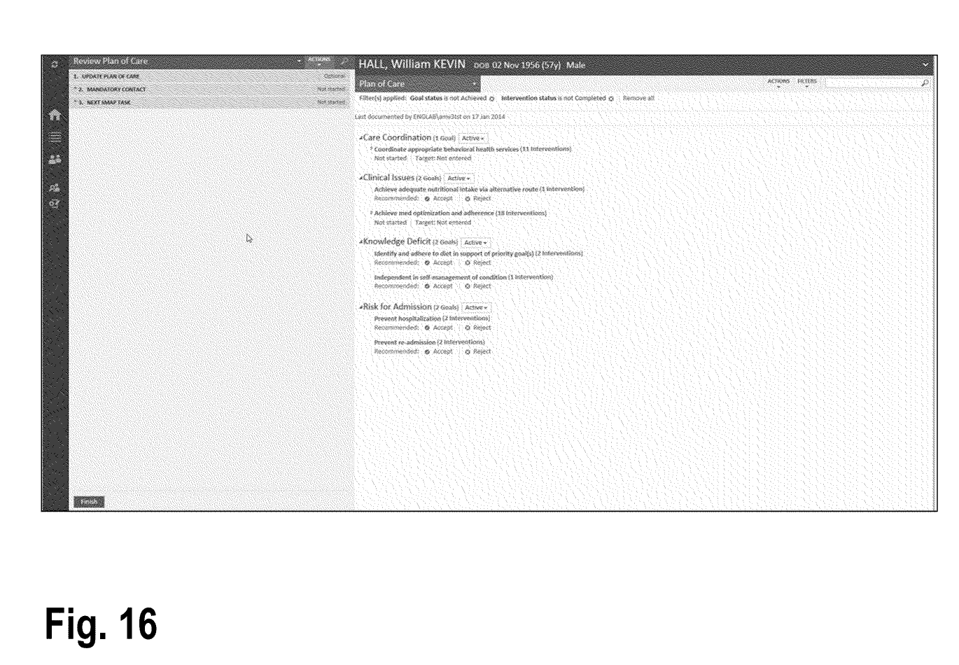

Continuing with the above example, based on the responses received from the SNU Follow-Up Assessment, the management computing entity 100 triggered/initiated several PGI workflows to be displayed by the care manager computing entity 110. In one embodiment, in addition to causing display of the PGI workflows, the management computing entity 100 can author the PGI workflows in a recommended state onto a patient's plan of care and store the same in association with the corresponding patient's information/data. As shown in FIG. 16, the management computing entity 100 triggered/initiated four PGI workflows in a recommended state for Mr. Hall. The recommended state allows the care manager (e.g., operating a care manager computing entity 110) to accept or reject each individual PGI workflow. If the care manager (e.g., operating a care manager computing entity 110) rejects a PGI workflow, the management computing entity 100 may require the care manager to input the reason for the rejection. The management computing entity 100 can then store the rejected PGI workflow, the reason for the rejection, the rejecting party, the time and date of the rejection, and/or the like in association with the patient's information/data. This can be used to create a PGI workflow history. For instance, if the same assessment is provided for the same patient another time, the management computing entity 100 can provide all relevant PGI workflows and a history for any previously rejected PGI workflows that are being recommended again. This can provide the care manager with context as to why a specific PGI workflow was rejected previously. However, if the care manager (e.g., operating a care manager computing entity 110) accepts the PGI, the management computing entity 100 can author the PGI workflow onto the patient's plan of care and request appropriate detailed information/data for each PGI workflow from the care manager (e.g., operating a care manager computing entity 110).

Continuing with the above example, the Care Coordination problem of the PGI workflow—comprises one goal, which can be accepted or rejected: Coordinate appropriate behavioral health services. This goal comprises eleven interventions, which can be accepted or rejected. The Clinical Issues problem of the PGI workflow comprises two goals, which can be accepted or rejected: Achieve adequate nutritional intake via alternative route and achieve medication optimization and adherence. These two goals comprise 19 interventions, which can be accepted or rejected. The Knowledge Deficit problem of the PGI workflow comprises two goals, which can be accepted or rejected: identify and adhere to diet in support of priority goals and independent self-management of condition. These two goals comprise three interventions, which can be accepted or rejected. And the Risk for Admission problem of the PGI workflow comprises two goals, which can be accepted or rejected: prevent hospitalization and prevent re-admission. These two goals comprise four interventions, which can be accepted or rejected. As shown in these figures, exemplary interventions (e.g., one or more tasks to help accomplish the one or more objectives) may be: (1) educate in enteral feedings via G-tube or PEG, (2) educate in importance of regular eating patterns, (3) educate in low fat, low cholesterol diet, and/or the like. As will be recognized, a variety of other approaches and techniques can be used to adapt to various needs and circumstances.

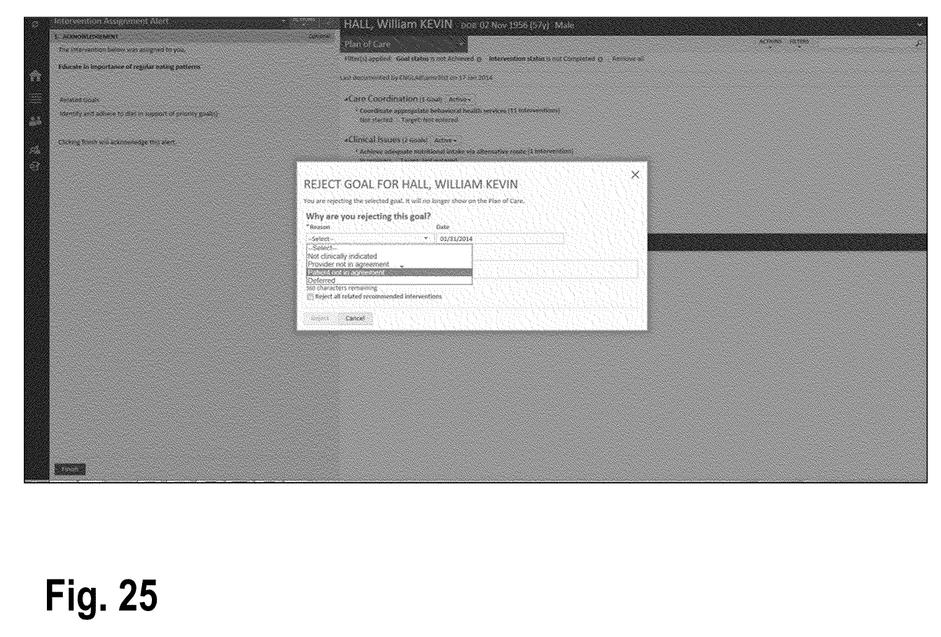

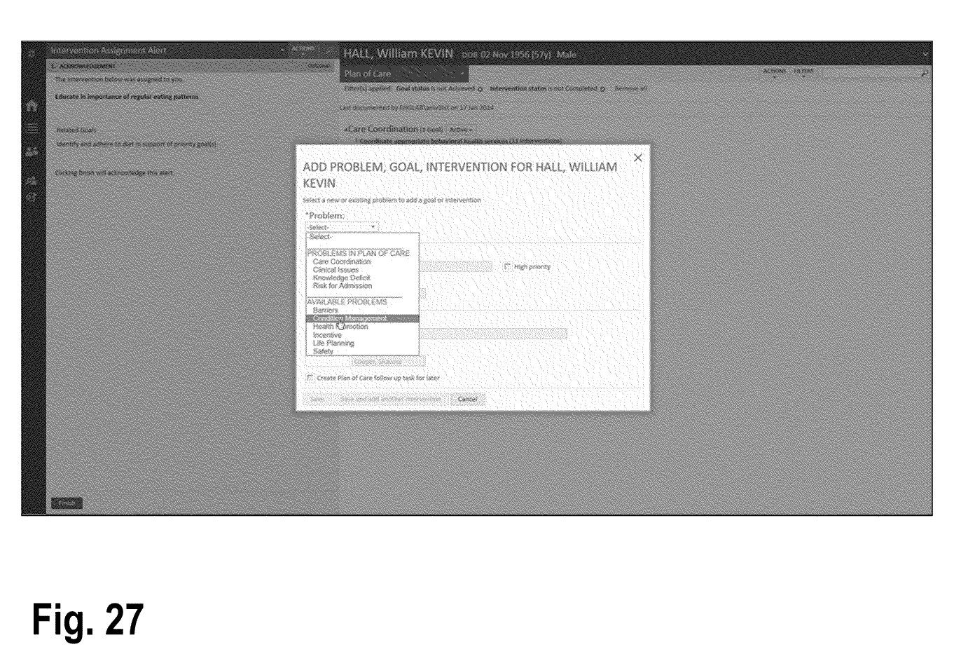

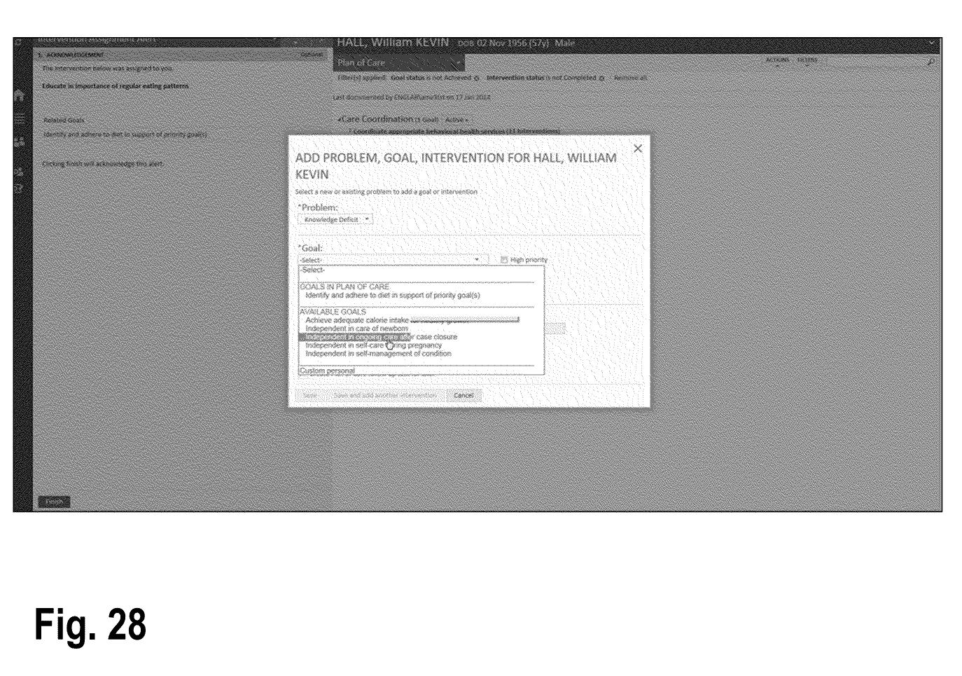

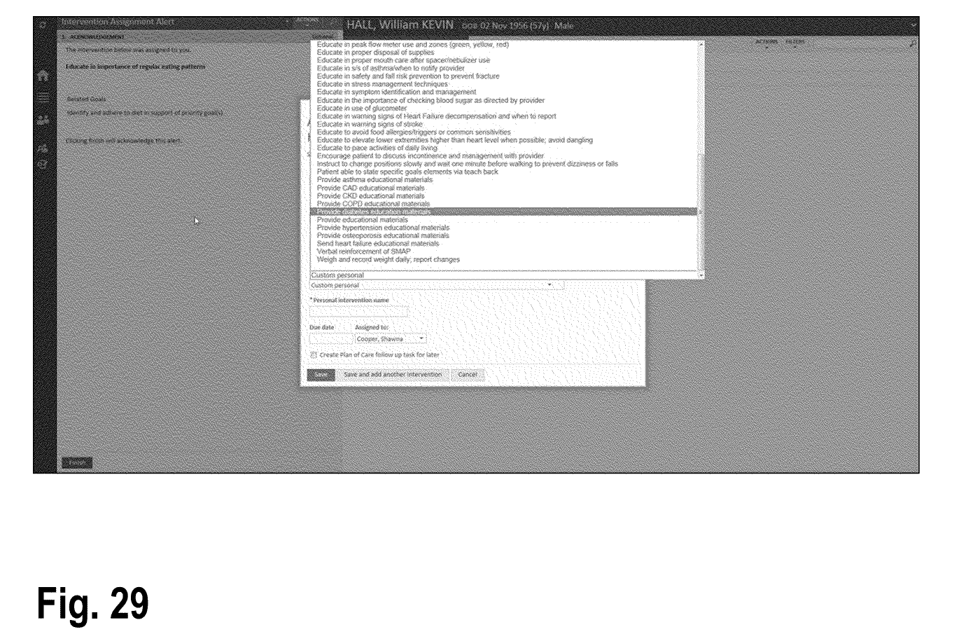

As with the PGI workflow, if the care manager (e.g., operating a care manager computing entity 110) rejects a goal or intervention of an accepted PGI workflow, the management computing entity 100 may require the care manager to input the reason for the rejection—see FIG. 25. In this example, the reasons for rejecting a goal or intervention may include: (1) the goal or intervention not being clinically indicated, (2) the provider not being in agreement, (3) the patient not being in agreement, (4) deferred, and/or the like. The management computing entity 100 can then store the rejected goal or intervention, the reason for the rejection, the rejecting party, the time and date of the rejection, and/or the like in association with the patient's information/data. However, if the care manager (e.g., operating a care manager computing entity 110) accepts a goal and/or intervention, the management computing entity 100 can author the goal or intervention from the PGI workflow onto the patient's plan of care and request the appropriate information/data for each goal and/or intervention from the care manager (e.g., operating a care manager computing entity 110). This step can be used to create one or more tasks for the care manager and/or patient. As will be recognized, any number and form of PGI workflows can be used to adapt to various needs and circumstances. As shown in FIGS. 27-30 and similar to assessments, topics/sections, and/or questions, PGI workflows can be customized for use in assessments. In these figures, to create a PGI, a care manager (e.g., operating a care manager computing entity 110) or other user can select or input a problem, select or input the goals associated with the problem, and/or select or input the interventions associated with the goals. For example, a customized goal for a problem from the content library may be to “Walk daughter down the aisle at wedding.” Such customized goals may be more meaningful to patients in completing the goals and corresponding interventions. FIG. 27 lists exemplary problems. FIG. 28 lists exemplary goals for the selected problem. And FIG. 29 lists exemplary interventions for accomplishing the selected goal. As will be recognized, a variety of other approaches and techniques can be used to adapt to various needs and circumstances. If desired, the management computing entity 100 can store customized PGI workflows in the content library for use by others in association with a unique PGI identifier.

In one embodiment, as indicated, a care manager (e.g., operating a care manager computing entity 110) may be requested or required to input the detailed information/data for each PGI workflow, goal, and/or intervention (see FIGS. 16-24). The detailed information/data for the goals and/or interventions may comprise a status. For example, the status may be “not started,” “in progress,” “achieved,” “inactive,” “rejected,” and/or the like. Further, the goals and interventions may each include a start date, target completion date, a priority, an indication as to whom the goal/intervention is assigned, goal/intervention notes, follow up dates, and/or the like. After receiving the appropriate input (e.g., via the care manager operating care manager computing entity 110), the management computing entity 100 can record and store the detailed information/data for each PGI workflow, goal, and/or intervention along with a timestamp and author in association with the corresponding patient's information/data. The timestamp and author may be used by the management computing entity 100 to record a history of events for the same. For example, the notes section may be used by the management computing entity 100 to cause display of a timeline of notes upon request sorted and displayed in a sequential manner. In one embodiment, with detailed information/data for the various PGI workflows, goals, and interventions, the management computing entity 100 can cause display of the detailed information/data to various users. For example, by clicking on, selecting, hovering over, or otherwise activating, the management computing entity 100 can cause display of at least a portion of the detailed information/data corresponding to a PGI workflow, goal, and/or intervention. As will be recognized, a variety of other approaches and techniques can be used to adapt to various needs and circumstances.

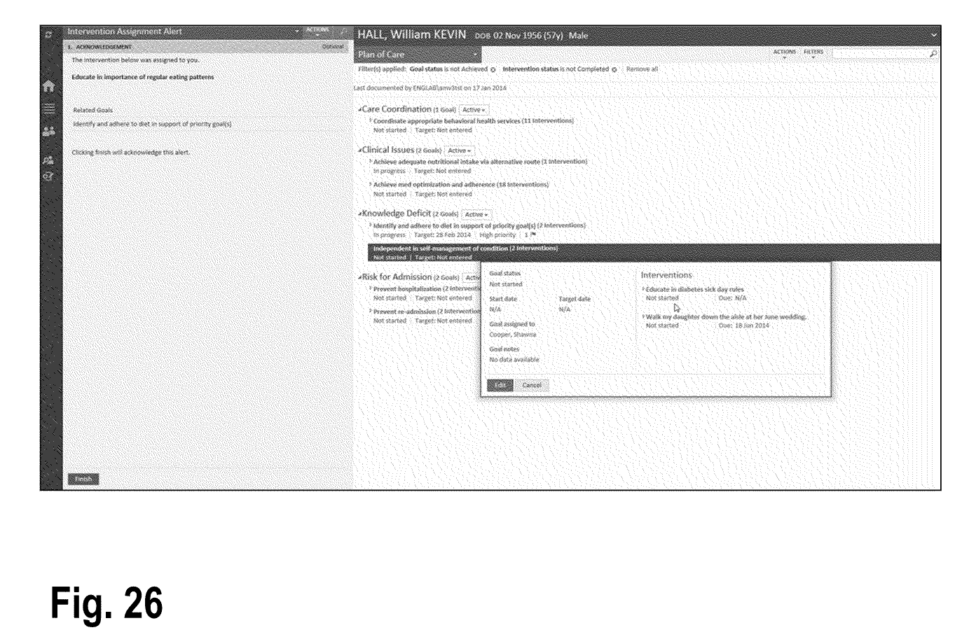

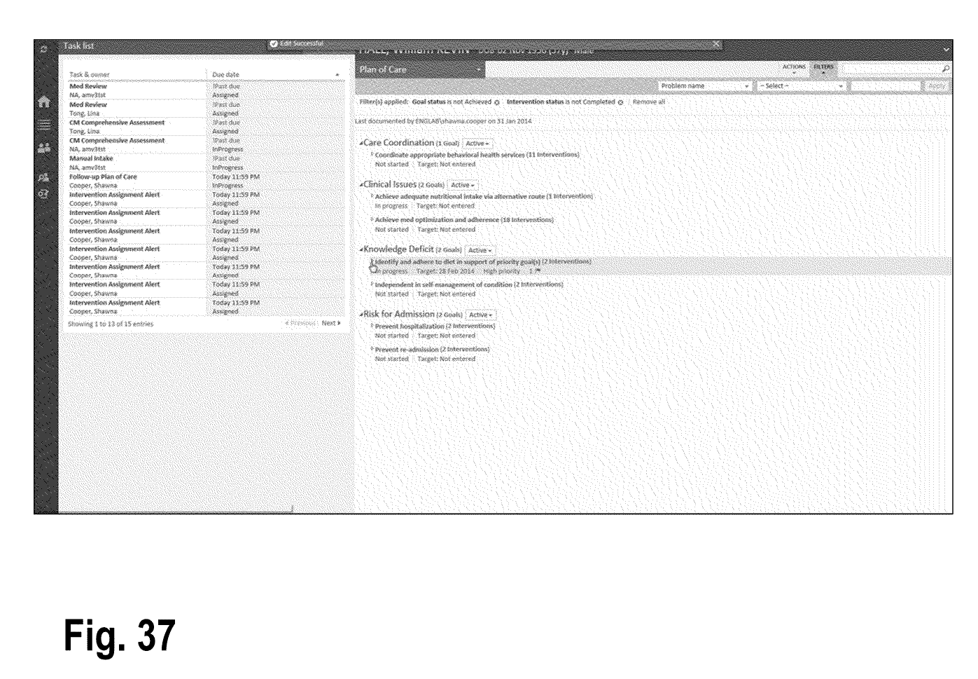

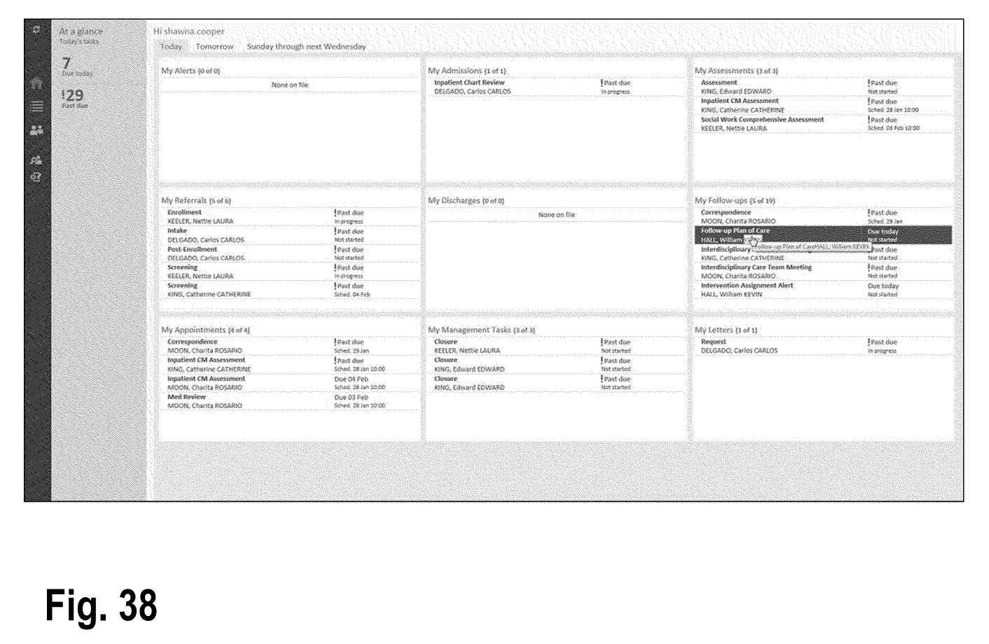

In one embodiment, the management computing entity 100 executing/providing the plan of care platform can also provide the care manager (e.g., operating the care manager computing entity 110) with the ability to initiate other workflows and processes, such as selecting or defining whether the goals and/or interventions become tasks (e.g., automatically creating/generating a task when an intervention is marked for follow-up), whether and how to notify the appropriate parties assigned the goals and/or interventions, when to follow up regarding the goals and/or interventions, whether to create/generate SMAPs for patients, and/or the like (Block 415 of FIG. 4). For example, a care manager can assign one or more goals or interventions (e.g., tasks) to one or more care managers for monitoring and/or completion (e.g., an indication as to whom the goal/intervention is assigned). Responsively, the management computing entity 100 can store the assigned goal and/or intervention in association with the appropriate care manager's profile (both the assigning care manager and the assigned care manager)—see FIG. 26. This can allow the management computing entity 100 to provide the assigned goal and/or intervention for display in the appropriate area of the interface and provide corresponding notifications. For example, FIGS. 37 and 38 show assessments, follow ups, interventions, and the like shown in the appropriate task lists, tasks due today, tasks past due, alerts, follow-ups related to plans of care, appointments and other calendar functions, various management tasks, and/or the like. These may have been created by that particular care manager or assigned to him or her. In various embodiments, this can allow care managers to track the tasks they need to perform for patients. Further, once tasks are performed or missed, the management computing entity 100 can store updates to the plans of care for the corresponding patients. For example, a care manager (e.g., operating a care manager computing entity 110) can update detailed information/data for goals and interventions as progress is made or as otherwise is desired for assessments, PGI workflows, and/or the like. Thus, detailed information/data for assessments, PGI workflows, and/or the like can be updated and presented to various interested parties.

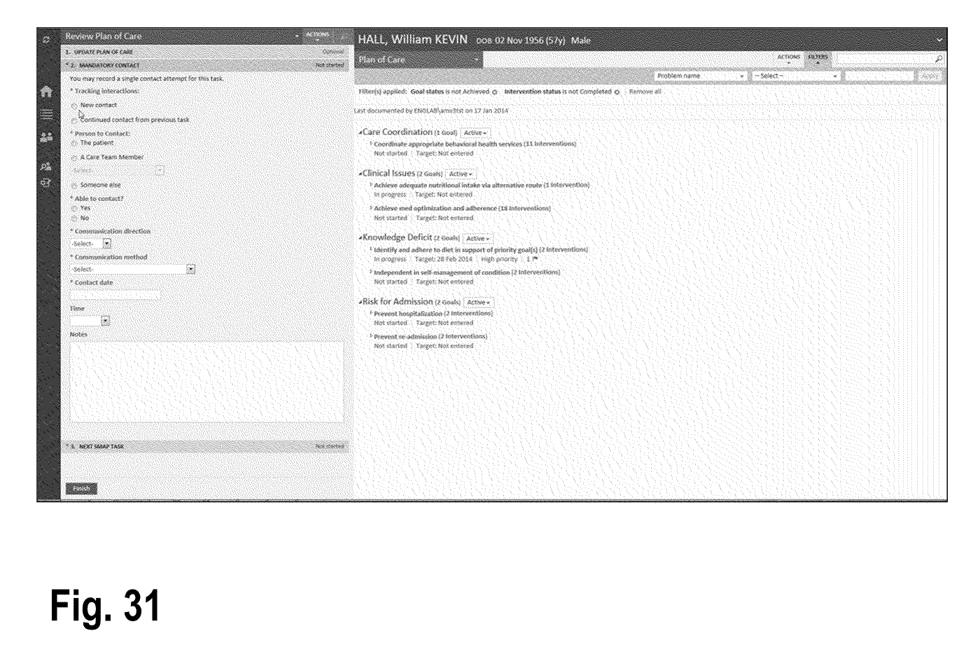

In one embodiment, a care manager (e.g., operating a care manager computing entity 110) can track or schedule interactions with a patient (FIG. 31). As shown in FIG. 31, a care manager (e.g., operating a care manager computing entity 110) can input information/data about or schedule each interaction with a patient. This information/data may include who should make/did make contact with the patient, when the contact should be/was made, how the contact should be/was made, and any notes regarding the contact. The management computing entity 100 can then store the same in association with the patient information/data and also store information/data about the actual contact with the patient.

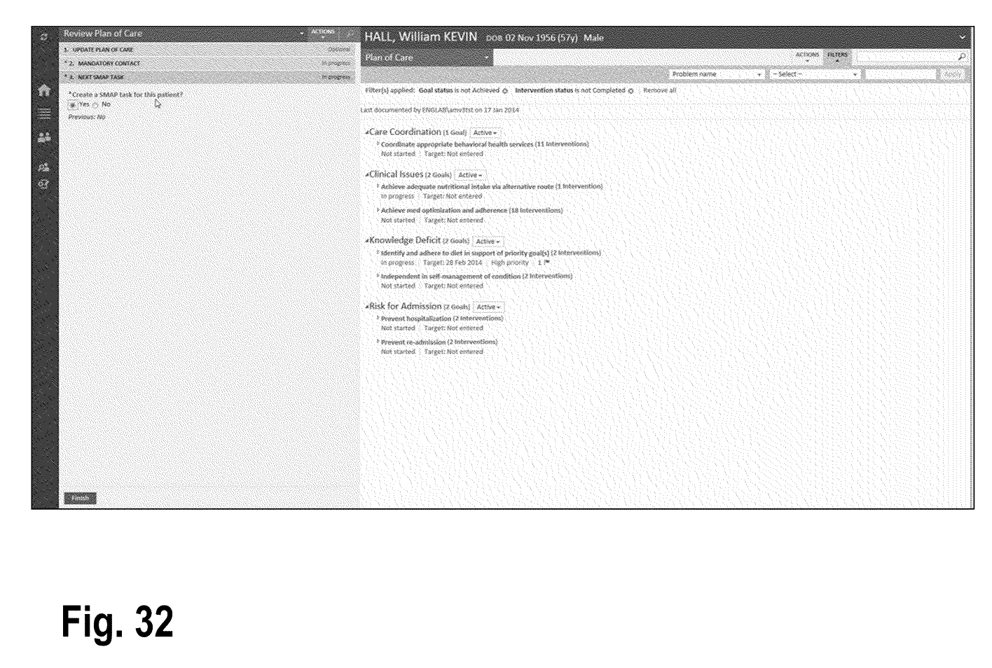

In one embodiment, a care manager (e.g., operating a care manager computing entity 110) can create/generate one or more SMAPs (self-management action plans) to better engage the patient in his or her care (FIGS. 32-36 and Block 420 of FIG. 4). That is, in addition to creating/generating and assigning tasks (e.g., from PGI workflows, goals, and/or interventions) to care managers, a care manager (e.g., operating a care manager computing entity 110) can also create/generate tasks for the same to be assigned to patients. To do so, as shown in FIG. 32, a care manager (e.g., operating a care manager computing entity 110) can select an appropriate option to create a SMAP. After selecting the appropriate option to create a SMAP, the care manager (e.g., operating a care manager computing entity 110) can identify any PGI workflows, goals, and/or interventions to include in the SMAP. In another embodiment, the management computing entity 100 can automatically include all PGI workflows that are available to be added for inclusion into a SMAP as a default. In this embodiment, the care manager is not forced to select each individual PGI workflow for inclusion. By selecting the PGI workflows, goals, and/or interventions to include in a SMAP, the care manager (e.g., operating a care manager computing entity 110) determines/identifies the tasks the management computing entity 100 should assign and provide to the patient for completion. That is, the SMAPs can be used to create tasks a patient needs to perform, which can be provided or displayed to the patient (e.g., operating a patient computing entity 115). The management computing entity 100 can add the tasks for the SMAP on a calendar or task list for the patient with reminders as desired. Additionally, the management computing entity 100 can provide the care manager (e.g., operating a care manager computing entity 110) with a list of materials that can be provided to the patient with the tasks for the SMAP. The materials may be used to educate and inform the patient of how to perform the tasks, the importance of performing the tasks, risks associated with not performing the tasks, and/or the like. As will be recognized, in one embodiment, the materials can be electronically provided to the patient from the content library via an interface, email, download, and/or the like. In another embodiment, the management computing entity 100 can add any materials to a care manager's letter queue to be mailed to a patient along with any necessary tasks (see My Letters on FIG. 38) as a reminder to the care manager.

In one embodiment, the management computing entity 100 can also provide various reporting capabilities associated with assessments, topics/sections, questions, PGI workflows, and/or the like (Block 425 of FIG. 4). For example, the management computing entity 100 can generate and provide reports on which recommended PGI workflows are most typically accepted onto plans of care and which PGI workflows are most often rejected. The management computing entity 100 can also generate and provide reports on completion numbers for interventions, goals, and PGI workflows. The management computing entity 100 can also generate and provide reports on actual usage of assessments, topics/sections, questions, and/or the like. As will be recognized, a variety of other reports can be generated and provided to adapt to various needs and circumstances.

### IV. Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for a plan of care, the method comprising:
providing an interactive assessment for a patient, the interactive assessment comprising a plurality of sections, each section comprising a plurality of questions to which responses can be provided;
receiving a response to at least one of the plurality of questions;
determining whether a workflow is associated with the response to the at least one of the plurality of questions; and
after determining that a workflow is associated with the response to the at least one of the plurality of questions, providing the workflow for a plan of care for the patient, the workflow comprising one or more goals and one or more interventions.

2. The method of claim 1, wherein at least one of the plurality of questions comprises conditional logic such that receiving a particular response causes display of one or more additional questions.

3. The method of claim 1, wherein each of the plurality of questions is associated with a unique question identifier.

4. The method of claim 3 further comprising storing each response to the respective plurality of questions in association with the respective unique question identifiers.

5. The method of claim 3 further comprising storing multiple responses from multiple interactive assessments in association with the unique question identifier for the at least one of the plurality of questions.

6. The method of claim 1, wherein the workflow is provided in a recommended state, the recommended state allowing the workflow to be accepted or rejected.

7. The method of claim 6, wherein accepting the workflow generates at least one task for completing at least one of the one or more interventions.

8. The method of claim 6, wherein the at least one task is assigned to a care manager for completion or the at least one task is assigned to a patient for completion.

9. The method of claim 6 further comprising determining whether the patient satisfies one or more criteria for providing the workflow.

10. An apparatus comprising at least one processor and at least one memory including program code, the at least one memory and the program code configured to, with the processor, cause the apparatus to at least:
provide an interactive assessment for a patient, the interactive assessment comprising a plurality of sections, each section comprising a plurality of questions to which responses can be provided;
receive a response to at least one of the plurality of questions;
determine whether a workflow is associated with the response to the at least one of the plurality of questions; and
after determining that a workflow is associated with the response to the at least one of the plurality of questions, provide the workflow for a plan of care for the patient, the workflow comprising one or more goals and one or more interventions.

11. The apparatus of claim 10, wherein at least one of the plurality of questions comprises conditional logic such that receiving a particular response causes display of one or more additional questions.

12. The apparatus of claim 10, wherein each of the plurality of questions is associated with a unique question identifier.

13. The apparatus of claim 12, wherein the memory and program code are further configured to, with the processor, cause the apparatus to store each response to the respective plurality of questions in association with the respective unique question identifiers.

14. The apparatus of claim 12, wherein the memory and program code are further configured to, with the processor, cause the apparatus to store multiple responses from multiple interactive assessments in association with the unique question identifier for the at least one of the plurality of questions.

15. The apparatus of claim 10, wherein the workflow is provided in a recommended state, the recommended state allowing the workflow to be accepted or rejected.

16. The apparatus of claim 15, wherein accepting the workflow generates at least one task for completing at least one of the one or more interventions.

17. The apparatus of claim 15, wherein the at least one task is assigned to a care manager for completion or the at least one task is assigned to a patient for completion.

18. The apparatus of claim 15, wherein the memory and program code are further configured to, with the processor, cause the apparatus to determine whether the patient satisfies one or more criteria for providing the workflow.

19. A computer program product for a plan of care, the computer program product comprising at least one non-transitory computer-readable storage medium having computer-readable program code portions stored therein, the computer-readable program code portions comprising:
an executable portion configured to provide an interactive assessment for a patient, the interactive assessment comprising a plurality of sections, each section comprising a plurality of questions to which responses can be provided;
an executable portion configured to receive a response to at least one of the plurality of questions;
an executable portion configured to determine whether a workflow is associated with the response to the at least one of the plurality of questions; and
an executable portion configured to after determining that a workflow is associated with the response to the at least one of the plurality of questions, provide the workflow for a plan of care for the patient, the workflow comprising one or more goals and one or more interventions.

20. The computer program product of claim 19, wherein at least one of the plurality of questions comprises conditional logic such that receiving a particular response causes display of one or more additional questions.

21. The computer program product of claim 19, wherein each of the plurality of questions is associated with a unique question identifier.

22. The computer program product of claim 21 further comprising an executable portion configured to store each response to the respective plurality of questions in association with the respective unique question identifiers.

23. The apparatus of claim 21 further comprising an executable portion configured to store multiple responses from multiple interactive assessments in association with the unique question identifier for the at least one of the plurality of questions.

24. The computer program product of claim 19, wherein the workflow is provided in a recommended state, the recommended state allowing the workflow to be accepted or rejected.

25. The computer program product of claim 24, wherein accepting the workflow generates at least one task for completing at least one of the one or more interventions.

26. The computer program product of claim 24, wherein the at least one task is assigned to a care manager for completion or the at least one task is assigned to a patient for completion.

27. The computer program product of claim 24 further comprising an executable portion configured to determine whether the patient satisfies one or more criteria for providing the workflow.
